(19) United States
(12) Patent Application Publication
(10) Pub. No.: US 2025/0198408 A1
(43) Pub. Date: Jun. 19, 2025

(54) Compressor installation having cooling, and method for operating a compressor installation

(71) Applicant: KAESER KOMPRESSOREN SE, Coburg (DE)

(72) Inventor: Dirk Simross, Coburg (DE)

(21) Appl. No.: 18/980,688

(22) Filed: Dec. 13, 2024

(30) Foreign Application Priority Data
Dec. 13, 2023 (DE) 102023135013.7

(51) Int. Cl. F04C 29/04; F04C 18/16

(52) U.S. Cl. CPC F04C 29/04; F04C 18/16

(57) ABSTRACT

A compressor installation includes a compressor for compressing gas to generate a compressed gas, and a cooling installation having an oil cooler for cooling oil heated by the compressor, a compressed gas cooler for cooling the gas completely or partially compressed to the compressed gas, and a housing cooler for cooling a housing or part of the housing of the compressor. The oil cooler, the compressed gas cooler, and the housing cooler are each prepared to achieve the cooling by a coolant flow from a liquid coolant. In each case, the coolant flow of the oil cooler, the coolant flow of the compressed gas cooler, and the coolant flow of the housing cooler is an individual, actuatable control means to individually control each of the coolant flows such that a cooling output in each case is individually controllable for the oil cooler, the compressed gas cooler, and the housing cooler.

### CROSS-REFERENCE TO RELATED APPLICATIONS

This application claims priority to German Patent Application No. 102023135013.7 filed on Dec. 13, 2023, the entire contents of which are incorporated herein by reference.

The present invention relates to a compressor installation for compressing a gas for generating compressed gas, in particular compressed air, wherein the compressor installation has a cooling installation. Moreover, the present invention relates to a method for operating a compressor installation having a cooling installation.

Compressors for compressing a gas for generating compressed gas can also be referred to as compressed gas compressors. The latter thus serve to generate the compressed gas, often specifically compressed air. This compressed air, or other compressed gas, is provided in particular for subsequent industrial use. Explanations hereunder pertaining to compressed air also relate in an analogous manner to other compressed gases.

For functional reasons, heat is created in the generation of compressed air. The compressed air as well as the compressor, in particular the housing of the latter, are heated and therefore have to be cooled. Housing coolers for cooling a housing of the compressor, or part thereof, can be provided for cooling, said housing coolers often also being referred to or embodied as jacket coolers. In the latter, a cooling medium, which can synonymously also be referred to as coolant, in particular water, can flow through the housing cooler and cool the housing as a result. Moreover, a compressed gas cooler, which is disposed in a part of a line system that conducts the compressed gas, in particular the compressed air, can be provided. A heat exchanger can in particular be provided here, through which a cooling medium, or coolant, in particular water, likewise flows. Often, oil is also required when generating the compressed gas, in particular for lubricating the components of the compressor. Such oil is likewise heated and can be cooled by an oil cooler which can in particular have a heat exchanger. A cooling medium, or coolant, in particular water, likewise flows through this heat exchanger.

Efficient cooling can be achieved in that all coolers mentioned, wherein a plurality of each of the mentioned coolers can also be provided, are connected to a primary cooling circuit. In particular, the cooling units can be completely or partially connected in parallel so that ideally a cooler does not receive the water, already heated, of an upstream cooler, as would occur in a series connection.

As a result of the parallel connection, the individual coolers receive their cooling water content depending on the flow resistance of their parallel branch. By suitably conceiving these parallel branches, or the coolers per se, the coolers receive in each case an appropriate amount of coolant, thus in particular water.

However, it has been demonstrated that the cooling requirement, and thus the requirement in terms of coolant, thus cooling water, may vary. In order to account for this, the flow rate of the coolant in the primary circuit can be correspondingly adapted. However, if the variation of the coolant requirement is different in the individual coolers, optimal cooling in one cooler can lead to excessive or insufficient cooling in another cooler.

In order to adapt such sub-optimal cooling, corresponding valves by way of which the respective coolant inflow to the individual cooling units can be adjusted can be provided and adapted. However, such adapting can be time-intensive, because a technician has to perform or alter corresponding settings for this purpose. The result also depends on the individual skills of the technician.

As a further improvement, individual cooling in which each cooler has its own dedicated cooling circuit could be provided. However, such a solution is complex and therefore should not necessarily be recommended.

Known from document WO 2022/163079 A1 is a cooling unit for compressors, in which, inter alia, the amount of cooling liquid can be adapted.

The present invention is thus based on the object of addressing at least one of the problems mentioned above. The intention is in particular to propose a solution in which adapted cooling for a compressor installation having a cooling installation is achieved in a simple manner. At least, an alternative solution to previously known solutions is to be proposed.

According to the invention, a compressor installation according to claim 1 is proposed. Thus, a compressor installation having a compressor and a cooling installation is provided. The compressor, which can synonymously also be referred to as compressed gas compressor, is provided for compressing a gas for generating compressed gas. In particular, a compressed air compressor for generating compressed air is proposed. This compressed air compressed generates compressed gas, or compressed air, in a manner fundamentally known.

Moreover provided is a cooling installation which has at least one oil cooler, a compressed gas cooler and a housing cooler. The oil cooler is provided for cooling oil heated by the compressor. For this purpose, the oil can flow from the compressor through a heat exchanger in which said oil discharges its heat to a liquid coolant, in particular water, thus cooling water.

The compressed gas cooler, of which a plurality can also be provided, is provided for cooling the compressed gas. For this purpose, the compressed gas flows through this compressed gas cooler and in the process discharges heat to a liquid coolant. It is also considered that a compressor has a plurality of compression stages in such a way that the gas after the first compression stage is brought to a first pressure level, the latter potentially also already being considered to be compressed gas. To this extent, however, the compressed gas is not yet compressed to the final pressure level, so that a partially compressed gas can be assumed. However, a compressed gas cooler can also be provided for this partially compressed gas which, as mentioned, may simply also be referred to already as compressed gas, said compressed gas cooler in this case potentially being disposed between two compressor stages. If there are at least two compressor stages, a compressed gas cooler can at least again be provided after the second compressor stage, said compressed gas cooler cooling the compressed gas that is delivered by the second compressor stage mentioned.

The housing cooler, of which a plurality also may be provided, is provided for cooling a housing or part of the housing of the compressor. The entire physical design embodiment of the compressor, or of the part thereof, can fundamentally be considered to be the housing of the compressor here. Therefore, this is not only a housing in the context of a cover of the compressor, but is the compressor as a physical object.

For these coolers, it is thus proposed that the oil cooler, the at least one compressed gas cooler and the at least one housing cooler are in each case prepared to achieve cooling by a coolant flow of a liquid coolant, in particular water. Each of these coolers thus has at least one flow duct through which the coolant can flow. For reasons of principle, the coolers mentioned are thus coolers which, for cooling, utilize a coolant flow of a liquid coolant, thus in particular coolers which are cooled by means of water, or cooling water. A coolant flow thus flows through each cooler during operation.

It is provided in particular that provided for the coolant flow of the oil cooler, the coolant flow of at least one of the at least one compressed gas cooler, and the coolant flow of at least one of the at least one housing cooler is in each case an individual, actuatable control means so as to individually control each coolant flow in such a way that a cooling output is in each case individually controllable for the oil cooler, the at least one of the at least one compressed gas cooler and the at least one of the at least one housing cooler. The control means being actuatable means that the latter is actuatable by way of an open-loop or closed-loop control, thus not manually actuatable. It may also be referred to as automatically actuatable. In order for the control means to be actuatable, the latter can have, for example, a control input by way of which the control means can receive a control signal.

It is also considered that, for example one of the coolers, for example the compressed gas cooler, has two or more sub-coolers, or is divided into two or more sub-coolers, for example into an intercooler and an aftercooler, and both sub-coolers are in each case controllable by way of a control means. In this way, the respective coolant flow for each of the two or more sub-coolers is controllable. For this purpose, the sub-coolers can be connected so as to be mutually parallel. Individually controlling in each case one coolant flow through each of the sub-coolers can be designed in such a way that additionally, or exclusively, the distribution of an overall coolant flow among the sub-coolers is controlled.

For example, two housing coolers, which may also be referred to as jacket coolers, can be connected in parallel in such a way that a coolant flow is divided among these two housing coolers, wherein only one control means is provided together for both housing coolers. This control means controls the housing coolers and thus each individual housing cooler, or the corresponding coolant flow, individually to such an extent that controlling takes place independently for controlling the coolant through the oil cooler and independently for controlling the coolant flow through the compressed gas cooler.

A primary cooling circuit is preferably provided for all coolers in that these coolers are completely or partially connected to one another in a parallel connection. However, this does not preclude that two coolers, for example two housing coolers, which can be designed as jacket coolers, are also connected in series. Two such jacket coolers connected in series can also be considered to be one common housing cooler. If two or more sub-coolers are mutually connected in parallel, it is considered that they are connected in series in the primary cooling circuit to the other coolers, or some of the latter, and as a result receive the entire coolant flow of the primary coolant circuit, but are nevertheless individually controllable due to their mutually parallel connection.

In any case, it is proposed, despite the possibility of continuing to use a common primary cooling circuit, to nevertheless provide an individual control capability. In this way, each individual control means can be designed as a controllable valve, or as a controllable pump, or some individual control means are designed as a controllable valve and others are designed as a controllable pump. As a result, continuous adaptation of the coolant flow of each cooler is possible, and each cooler can be operated at an operating point optimal therefor as a result. Thus, each cooler can be optimally operated. For example, if an increased cooling requirement occurs for the oil cooler, the coolant flow of the latter can be increased without the coolant flow of the other coolers also being increased.

Conversely, it has been recognized that optimal cooling does not necessarily mean that cooling down is performed as far as possible, but the ability of the compressed gas to discharge or absorb moisture also depends in particular on the temperature of said compressed gas. If a compressed gas, in particular compressed air, is cooled down excessively, it can absorb less moisture, or tends to discharge moisture, respectively. If this is undesirable, it can be prevented or otherwise promoted by correspondingly controlling cooling. In this way, the cooling output of a cooler can also be individually reduced while the cooling output of the remaining coolers is maintained or optimized. This is considered, for example, when the volumetric flow of cooling water is limited, or a certain (minimum) water outlet temperature from the entire system is required.

It has been recognized in particular here that the proposed individual control has the effect that the oil cooler as well as the at least one housing cooler and also the at least one compressed gas cooler, or their coolant flows, respectively, can in each case be controlled independently of one another. In this way, optimal cooling is possible for each cooler, this potentially also including minimizing of the overall required cooling output. It is to be noted here that when using a common primary cooling circuit, the common coolant flow, thus the sum of all coolant flows of the individual coolers, which thus may also be referred to as the total coolant flow, has to be recooled. If excessive cooling takes place in a cooler, this leads overall to more thermal input into the overall coolant flow, or total coolant flow, and this may lead to the recooler of the primary cooling circuit having to retrieve, i.e. recool, more heat from the common coolant flow.

It is also important that a gap between compressor housing and rotors is kept in an optimal range. Excessive cooling of the housing leads to a contraction and thus to contact between the rotor and the housing, as a result of which the gap would be permanently enlarged. In the case of insufficient cooling of the housing, an unnecessarily large gap is created between the rotor and the housing, which would lead to internal backflows of the already compressed gas.

Cooling the compressed air to an optimal value after the last compressor stage is also relevant. In the case of insufficient cooling, damage to components can arise, or the compressed air drying potentially does not function adequately.

In terms of the oil cooler it is relevant that the oil viscosity is kept in an ideally optimal range by way of the oil temperature. The power consumption increases in the case of excessively cold oil, while the wear increases in the case of excessively warm oil.

As a result of the solution proposed, the overall required recooling can thus also be minimized. However, lower electrical power consumption and optimal compressed air outlet temperature are often more relevant.

Often, a high temperature in the overall coolant flow, or total coolant flow, is desirable. In this instance, as much heat as possible is to be transmitted into the heating water as a result, the latter potentially being coupled to the overall coolant flow, or total coolant flow, or potentially using the latter in order to save fuel costs for the heating, for example. For this purpose, the temperature level has however to be correspondingly raised in such a way that the cooling water can be utilized for heating purposes, which may tend to be negative for cooling the compressor but may be expedient in the case of a corresponding requirement in terms of heat. As a result, investment costs can also be reduced.

It is provided in particular that the individual control means is provided, or is controlled, for non-manual control and/or for automatic control and/or for controlling by way of a control program.

According to one aspect, it is proposed that the oil cooler, the at least one compressed gas cooler, at least one of the latter should a plurality be present, and the at least one housing cooler, at least one of the latter should a plurality be present, are connected to a common coolant circuit, in particular primary coolant circuit, in particular completely or partially in a parallel connection.

Advantages pertaining thereto have already been described. It is thus furthermore possible to provide only one common coolant circuit, so that the use of a single recooler is also possible. However, a common heat discharge is particularly relevant here in order to enable an ideally complete utilization of the heat. Nevertheless, the possibility of individually controlling the individual coolers is achieved. Despite the common coolant circuit, an individual actuation of the individual coolers mentioned is thus possible.

This has in particular the advantage that, when improving existing systems and to some extent also any infrastructure already present, only the individual control means to the individual coolers have to be upgraded, be it in terms of planning or in terms of retrofitting. Of course, this does not preclude that after such optimization, or conjointly with such optimization, savings on the common coolant circuit can also be implemented such as the smaller basic design or size mentioned for the recooler for the common coolant circuit, or for the primary coolant circuit.

According to one aspect, it is proposed that the compressor has a plurality of compression stages, and the at least one compressed gas cooler has an intercooler and an aftercooler. The intercooler here is disposed between a first and second compression stage and there cools the gas which is partially compressed to the compressed gas, thus a compressed gas which has not yet reached the maximum pressure level provided in the overall system. Additionally, the aftercooler is provided at the outlet of the compressor, thus at the outlet of the last compression stage. In the case of two compression stages, the intercooler is thus provided after the second compression stage. There, the intercooler cools the compressed gas which has the final pressure level of the compressed gas, thus the pressure level after the second compression stage. It is provided here in particular that the intercooler and the aftercooler have in each case an individual, actuatable control means, or at least in each case one is assigned thereto. As a result, the intercooler and the aftercooler can in each case be likewise individually controlled. Also, the intercooler and the aftercooler can be mutually connected in parallel, and/or parallel to the remaining coolers to this end.

According to one aspect, it is proposed that the control means have in each case a controllable valve and/or a controllable pump.

As a result of the controllable valve, the control means is able to be implemented in a simple manner. The controllable valve, this also applying to all control means, can be centrally actuated by way of a controller in order to implement overall control in this way. A controllable valve requires only a minimum amount of control energy and is thus also cost-effective in terms of procurement as well as operation. As a result of the throttling of the valves, a higher pump output is required, which is then throttled down again. Individual pumps may be more economical in terms of the energy costs of the water recirculation.

One advantage of valves is that they close tightly. This can be advantageous when a plurality of compressors are operated on a common cooling system, but not all compressors always run simultaneously. At rest, the valves can be closed, so that there is no unnecessary throughflow.

A controllable pump can be more complex than a controllable valve because it is in that regard an active component, but they can achieve good control results. In particular, when using a controllable pump, the coolant flow which is in each case controlled thereby does not depend, or only to a minor extent, on an existing overall coolant flow. When all individual control means are designed as a controllable pump, a pump for pumping the overall coolant flow can also be dispensed with. Nevertheless, a combination can also be possible even when it is often advantageous to commit to one variant.

According to one aspect, it is proposed that the at least one housing cooler has at least one jacket cooler, in particular having two jacket sub-coolers, which are disposed in series, for cooling in each case one compressor stage and are prepared to use the same cooling flow for cooling, and to control the cooling flow by the same control means.

In such a jacket cooler, medium lines are thus provided in a jacket region of the compressor. As a result, corresponding coolant flows flow through the compressor, and the compressor is cooled as a result.

In the proposed jacket sub-coolers which are disposed in series, one jacket sub-cooler can cool in particular a jacket of the compressor of a first compression stage, and the second jacket sub-cooler can cool a second compression stage. In a preferred design embodiment, the cooler water first flows through the 2nd stage because the housing temperature and thus the housing size, in particular the size of the gaps, here has a greater effect on the backflows. It has thus been recognized that due to the geometry of the compressor it is expedient for the 2nd stage to be first passed through by the flow.

Due to the series connection, a better heat transfer, and thus a better cooling effect, can be achieved by virtue of the higher flow velocity than in the case of a parallel connection at the same volumetric flow of cooling water for the jacket cooling units.

The jacket cooling preferably receives a disproportionately large amount of cooling water, so that the pre-heating of the coolant in the 2nd stage is not of great importance for stage 1.

It is expedient here to consider these two jacket sub-coolers in combination as one jacket cooler and thus as one housing cooler, and to also control the latter by only one control means.

This is also based on the insight that two compression stages are also fundamentally loaded to a similar degree, and can therefore be controlled conjointly. The coordination and conjoined controlling of these two jacket coolers for the two compression stages has therefore been recognized as expedient. It has thus been recognized in particular that not every kind of individual control has to be only advantageous.

According to one aspect, it is proposed that a common control installation for controlling the coolant flows in a coordinated manner is provided, in particular that the common control installation is prepared for controlling the control means and connected to the control means.

It can be achieved as a result that not only the individual coolers per se are positively controlled, but that also a coordination of the coolers among one another can be achieved, and an overall cooling concept can in particular be achieved. It has also been recognized here that, in particular when using a common recooler for all coolers, and/or when using a common primary cooling circuit for all coolers, coordinated controlling of the coolant flows additionally makes it possible to conjointly take into account requirements set for or by the recooler, or for or by the primary coolant circuit. In this way, a temperature in the recooler and/or in the outflow of the common primary cooling circuit can also be taken into account and even controlled in a closed loop for example.

The common control installation can control all control means and for this purpose be connected to the latter. Such a connection relates in particular to a data connection. The latter can be by wire, which is often expedient because all of the coolers mentioned are often physically close to one another. Optionally, some elements could be more remote, such as the recooler, for example, in particular when the latter in one embodiment is provided as a cooling tower. Even then, wired communication and thus wired connection between the common control installation and the control means could be provided; however, a wireless connection, in particular a radio connection, is also considered.

The common control installation can as a result in particular be prepared for controlling the control means in such a way that the control installation receives actual values from the control means and/or transmits target values to the control means. The control installation can preferably be connected to additional sensors, in particular to temperature sensors, or else to moisture sensors which can be provided for detecting moisture of the compressed air, or of the compressed gas. Other properties of the compressed gas can also be detected and be transmitted to the common control installation for further consideration.

Moreover, the common control installation can be connected to control means which control the primary coolant circuit, for example, specifically in particular a flow rate of the primary coolant circuit. Other controlling tasks, for example of an additional or secondary common cooling circuit, should such a cooling circuit be provided, are also considered.

In this way, full controlling, and thus implementing an overall concept, is possible as a result of the common control installation, without any extensive investment in equipment being necessary. In particular, the control means can be provided as controllable valves, and in this instance only require control commands from the common control installation. Such a solution achieves a full control capability, while simultaneously only requiring a minor investment in equipment. The same applies also when one or a plurality of the control means are provided as pumps. Here too, these pumps are required, but overall do not represent any extensive investment in equipment, and can be actuated in a simple manner by way of the common control installation.

Overall, an optimal cooling result is able to be achieved for the entire compressor installation. It is to be repeated here that an optimal cooling result does not mean maximum cooling, but an optimal cooling result can also be seen in the light of the invested complexity. For example, a compressor having two compressor stages could be provided and, inter alia, one intercooler and one recooler could be provided. A desired temperature in the final compressed gas can be achieved by intense cooling of the recooler and by moderate cooling of the intercooler, or vice versa.

It has been recognized in particular that it is advantageous to cool the intercooler and the recooler differently in a targeted manner. The individually actuatable control means are in particular also proposed for this purpose.

It has been recognized in particular that ideally optimal cooling can be achieved or facilitated in that the compressed air is only cooled as intensely as necessary in the aftercooler, in particular so that a sufficient pressure condensation point can be achieved, and the compressed air is as warm as possible or permissible in the process, but the compressed air is simultaneously to be cooled as intensely as possible in the intercooler, because the drive output of the compressor drops as a result.

The housing temperature can also influence the compressed air temperature, and the compressed air temperature can also influence the temperature of the housing. The following control correlation has been recognized, for example. The outlet temperature from the 1^{st} compressor stage can also drop as a result of positive intercooling. It has been recognized specifically that in the case of a low temperature between the compressor stages, the intermediate pressure also drops there, and the pressure ratio of the 1^{st} compressor stage thus drops, this potentially leading to a lower temperature at the outlet of the 1^{st} compressor stage.

At least the cooling of the compressed air that is partly compressed (or very generally of the compressed gas) can also have an effect on the housing temperature, in particular also on the rotor temperature at least of the second compressor stage, through which said cooled compressed air that is partly compressed still flows.

In this way, all cooling temperatures can ultimately influence one another and in particular conjointly influence the overall cooling result of the compressor installation. All this can be coordinated by the common control installation. An optimal compressed gas product is then achievable. As a result, the electrical energy consumption of the compression can also be influenced.

As a result, a high temperature level can also be achieved at the water outlet of the overall coolant flow, or total coolant flow, as a result of which the heat can be further utilized.

According to one aspect, it is proposed that the compressor is a dry-running compressor and/or a screw compressor. The screw compressor is one which is designed to compress the gas, in particular the air to be compressed, by a movement of two mutually engaging screws. In particular, a continuous compression process can also be carried out as a result.

In the dry-running compressor, which can also be designed as a screw compressor, no oil is used for the compression procedure; in particular, no oil is injected into the compressed gas, or into the gas to be compressed to the compressed gas. It has been recognized that such dry-running compressors can heat up more intensely than others, in particular because the cooling effect of the injected oil is absent. Fields of application are sectors in which oil-free compressed air is required, for example in the pharmaceutical industry, foodstuff industry, clean room applications, etc. No contamination of the compressed air with oil must occur here. Such applications can thus nevertheless be positively cooled by the proposed solutions, without risking such contaminations. The concept mentioned according to these and any other embodiments is therefore proposed in particular for such dry-running compressors. The application range of a dry-running compressor can be extended in particular by the proposed cooling concept. In particular, the electrical energy consumption of the compressor can be reduced. A higher water outlet temperature in the overall coolant flow can be achieved in such a way that the waste heat arising can be better utilized.

According to one aspect, it is proposed that provided is/are at least one additional compressed gas cooler or two additional compressed gas coolers which in terms of a flow direction of the compressed gas is/are disposed behind the compressor so as to further cool the compressed gas there. For this purpose it is proposed that the at least one further compressed gas cooler, or the two or even more additional compressed gas coolers, is/are connected to the same primary coolant circuit as at least one of the already mentioned coolers, thus as the one or the plurality of compressed gas coolers and/or the one or the plurality of housing coolers and/or the oil cooler. As a result, further cooling of the compressed gas can be carried out, and by using these additional compressed gas coolers on the same primary coolant circuit, positively distributed cooling for the cooling gas can be achieved, without an extensive investment in equipment being required.

As a result of the additional compressed gas coolers it is possible that other heat exchangers are cooled at a higher level by the primary cooling system, for example in the process with heating water. It has been recognized that this may be expedient in order to operate the primary water system at higher temperatures in order to be able to utilize a large amount of heat but simultaneously generate very dry and/or cool compressed air.

It is to be stressed in particular here that such a use of so many compressed gas coolers is made possible, at least significantly improved, by the proposed controlling of the individual coolant flows by the control means in the first place. Without such individual control means for each of the compressed gas coolers, there would be the risk that an unnecessarily large amount of cooling water could flow through the heat exchangers. Any manual adjustment would always have to take into account the worst case, for example at a maximum output in the height of summer. In this instance, there would be the risk that the compressed air in most instances is unnecessarily intensely cooled. As a result, the operating volumetric flow drops in such a way that more compressed air would be consumed in many applications.

It is therefore provided in any case that each compressed gas cooler, thus also the additional compressed gas coolers, use in each case a coolant flow which is in each case controlled by a dedicated individual control means. A dedicated individual control means is thus one that controls the corresponding coolant flow. In other words, in the case of four compressed gas coolers, four control means are also provided, specifically one for each. These four control means can also be controlled in a coordinated manner by way of the common control installation.

Moreover or alternatively, it is provided that the at least one compressed gas cooler, or the plurality of additional compressed gas coolers, is/are connected to a second medium cooling circuit which can be referred to as secondary cooling circuit. This secondary cooling circuit can operate separately or be coupled to the primary cooling circuit, in particular by way of a heat exchanger.

As a result, an upgrade of this one or of these plurality of additional compressed gas coolers can be performed in a simple manner. They can be upgraded and controlled by way of the dedicated medium cooling circuit, specifically the second medium cooling circuit, thus the secondary cooling circuit. Heat from the primary cooling circuit can be discharged by way of the secondary cooling circuit by means of a heat exchanger when required. In this way, an inlet temperature into the primary cooling circuit can be reduced, which leads to better cooling and a lower electrical energy consumption. At the same time, a significantly lower amount of waste heat can however also be utilized. The second medium cooling circuit can be referred to as secondary cooling circuit. Such a secondary cooling circuit can thus be provided for cooling the primary cooling circuit and additionally cool the additional compressed gas coolers mentioned, thus provide the latter with coolant. As a result, this secondary cooling circuit has a dual function.

According to one aspect it is proposed that the oil cooler, the at least one compressed gas cooler and/or the at least one housing cooler have in each case one heat exchanger or are designed as a heat exchanger, and are prepared in such a way that the respective coolant flow is controlled by the respective control means as a coolant flow through the respective heat exchanger.

It thus becomes evident in particular that in the case of the use of a heat exchanger, which is considered for one, a plurality of or all of the coolers mentioned, the control means controls in each case the flow rate through the respective heat exchanger. As a result, the heat exchanger can thus be controlled, and the cooling output of the respective cooler as a result.

According to one aspect, it is proposed that the compressor installation, in particular the cooling installation, is prepared to control coolant flows individually, in each case as a function of a temperature. The preparation of the compressor installation or cooling installation can in particular lie in that corresponding temperature sensors are provided, and a corresponding control algorithm is provided. In particular, the common control installation can be connected to corresponding temperature sensors so as to receive temperature values from the temperature sensors as a result. A corresponding control unit, in particular a corresponding control program, which as a function of one or a plurality of received temperature signals emits at least one control command to be delivered to in each case one control means, or is prepared for the latter, can be implemented on the common control installation.

One coolant flow can in each case be controlled by one control means, and the control means can receive a corresponding control command. The control command can be established, by the control unit mentioned, as a function of at least one temperature value.

It is proposed in particular that controlling takes place as a function of at least one temperature from the list comprising the following temperatures:
an oil temperature, in particular of the oil heated by the compressor,
a compressed gas temperature,
a jacket temperature of a coolant which flows through a housing jacket of the compressor,
a temperature of the coolant,
an oil inlet temperature as the temperature of the oil entering the oil cooler,
an aftercooler gas outlet temperature as the temperature of the compressed gas exiting a, or the, aftercooler,
an intercooler gas outlet temperature as the temperature of the compressed gas exiting a, or the, intercooler,
an intercooler coolant outlet temperature as the temperature of the coolant exiting the intercooler,
an aftercooler coolant outlet temperature as the temperature of the coolant exiting the aftercooler,
a jacket cooler coolant outlet temperature as the temperature of the coolant exiting a, or the, jacket cooler,
a respective gas or coolant outlet temperature as the temperature of a compressed gas exiting at least one heat exchanger or exiting coolant, and
a compressor gas outlet temperature as the temperature from a compressor stage of the compressor and/or the compressor, and/or compressed gas exiting the compressor installation.

It is provided in particular in each case that the respective temperature is measured by a sensor system. Automated processing and taking into account of the temperature becomes possible as a result.

An oil temperature is thus a temperature of the oil heated by the compressor. Such an oil can in particular be used as a lubricant in the compressor, and it is heated as a result of the operation of the compressor. It has been recognized that temperature-dependent cooling control correspondingly enables the temperature of the oil to be controlled in a closed loop, and not only can positive cooling be guaranteed as a result, but it is also avoided that the oil is excessively cooled. The temperature of the oil also has an influence on the viscosity of the latter, so that excessively cold oil is not necessarily desirable. This closed-loop control of the temperature of the oil of the compressor, which may also be simply referred to as compressor oil, is able to be implemented here in a simple manner by the proposed control means.

Likewise, controlling can take place as a function of a compressed gas temperature, thus of a temperature of the compressed gas, in particular of the compressed air. In this way, the compressed gas temperature can thus also be controlled. It has been recognized in particular here that compressed gas should not be too hot, for which purpose the cooling is provided, but the compressed gas should also not be too cold.

A jacket temperature of a coolant which flows through a housing jacket of the compressor also provides information pertaining to the achieved cooling of the compressor. The measurement can take place directly within the housing, but this is not mandatory. The measurement typically takes place at the outlet, or outside the housing, at a higher point. In any case, the jacket temperature of the coolant can provide good information pertaining to the overall temperature of the compressor, is thus not limited to a punctiform temperature at a specific measuring point in the compressor.

A temperature of the coolant can very generally also be recorded at different locations. Said temperature can provide information pertaining to the cooling effect of the respective cooler with which the temperature is associated. In particular, the temperature of a coolant after exiting the respective cooler is to be used here, in order to evaluate the cooling output and/or the temperature in the respective cooler.

Moreover or alternatively, the temperature of the coolant prior to flowing into the cooler can also be used. A difference between an entering and exiting temperature of the coolant of a cooler is used in particular advantageously, wherein the cooling output of the cooler can be derived therefrom.

An oil inlet temperature as the temperature of the oil entering the oil cooler can advantageously be taken into account in order to control the coolant flow as a result. If the oil inlet temperature is very low, a smaller coolant flow may be sufficient, or no coolant flow at all may be provided; otherwise, a greater coolant flow can be expedient. The optimal oil temperature can depend on various factors, for example on a compressor rotating speed and on the type of oil used. In the case of compressors with speed control, the optimal oil temperature can continuously vary somewhat in line with the current rotating speed during operation. It has been recognized that all the above can be taken into account by the proposed solutions, in particular by taking into account the oil temperature.

An aftercooler gas outlet temperature is a temperature of the compressed gas exiting the aftercooler. The aftercooler gas outlet temperature provides information pertaining to how well the aftercooler was able to cool the compressed gas. In particular, a coolant flow through the aftercooler can be increased when the aftercooler gas outlet temperature is too high, in particular when the latter is too high for downstream components or processes. In any case, it is proposed to control the coolant flow by the aftercooler in an open loop, or closed loop, as a function of the aftercooler gas outlet temperature.

The intercooler gas outlet temperature refers to the temperature of the compressed gas exiting the intercooler. The cooling result of the intercooler can be detected in this way. It is proposed in particular that the coolant flow through the intercooler is controlled as a function of the intercooler gas outlet temperature.

An intercooler coolant outlet temperature is a temperature which refers to the temperature of the coolant at the outlet of the intercooler. It is proposed in particular to control the coolant flow through the intercooler as a function of the intercooler coolant outlet temperature. It is proposed in particular to reduce the coolant flow of the intercooler when the intercooler coolant outlet temperature decreases. It has been recognized in particular here that in the case of a low intercooler coolant outlet temperature the coolant has not absorbed sufficient heat in the intercooler, and therefore has passed through the intercooler too fast, so to speak. Therefore, the coolant flow can be reduced.

This applies in a very similar manner to the aftercooler coolant outlet temperature which refers to a temperature of the coolant exiting the aftercooler. It is also proposed here to control the coolant flow through the aftercooler as a function of the aftercooler coolant outlet temperature. The coolant flow through the aftercooler is preferably controlled in a closed loop as a function of the gas outlet temperature from the aftercooler.

A jacket cooler coolant outlet temperature describes a temperature of the coolant exiting the jacket cooler. Here too, a coolant flow through the jacket cooler is preferably controlled as a function of the jacket cooler coolant outlet temperature. The lower the jacket cooler coolant outlet temperature, the less thermal energy has been absorbed from the compressor per volume flowing through; and this is an indication that the coolant flow was too high.

It is also proposed to consider in each case a gas or coolant outlet temperature and to control as a function of the latter. The gas outlet temperature is a temperature of the compressed gas exiting a heat exchanger. The coolant outlet temperature is a temperature of the coolant exiting at least one heat exchanger. In both cases, the result of the heat exchanger can be evaluated by way of the corresponding temperature. In the case of a high gas outlet temperature from the heat exchanger, low cooling by the heat exchanger is to be assumed. In the case of a minor increase in the coolant temperature, which can be derived from considering a coolant inlet temperature in comparison to a coolant outlet temperature, it is to be assumed that a dwell time of the coolant in the heat exchanger was too short, at least could be prolonged, or in other words that the volumetric flow of coolant through the heat exchanger was too high or unnecessarily high, and could optionally be reduced or throttled.

It is particularly advantageous to conjointly consider the gas outlet temperature and the coolant outlet temperature of a respective heat exchanger. If the gas outlet temperature is low, or if the gas outlet temperature is only slightly above the coolant inlet temperature of the respective heat exchanger, this represents a positive cooling result. If the coolant outlet temperature here is simultaneously also low, it can be derived therefrom that the cooling of the compressed gas by the heat exchanger can also be achieved by a smaller coolant flow. In particular for the absolute evaluation it is proposed to compare the target values with the actual values. However, if the gas outlet temperature is high, in particular higher than a corresponding target value, the coolant flow nevertheless potentially has to be increased even when the coolant outlet temperature is already low. If the gas outlet temperature is high and the coolant outlet temperature is high, a conclusion pertaining to poor cooling can be drawn, and cooling could then be improved by increasing the coolant flow, because the high coolant outlet temperature in this case permits a conclusion pertaining to an excessive dwell time of the coolant in the heat exchanger to be drawn. In this case, the coolant flow can be increased.

A compressor gas outlet temperature is a temperature of a compressed gas exiting a compressor stage of the compressor. This compressor gas outlet temperature can denote the compressed gas exiting the compressor installation. In very general terms, it has been recognized that the compressor gas outlet temperature can be used to adjust a coolant flow as a function thereof. If this temperature is high, increasing the coolant flow can be expedient, in each case by way of the respective compressor stage at which the compressor gas outlet temperature is high. It is considered here, inter alia, to increase a coolant flow through a corresponding jacket cooler of the respective compressor stage if the compressor gas outlet temperature there is correspondingly high.

However, other considerations are also taken into account. Final compression temperatures primarily depend on the respective pressure ratio. Moreover, the rotating speed and the state of the stage have a decisive influence.

Intercooling can also have a decisive influence on the downstream stage as well as on the upstream stage. It is proposed to attempt to perform optimal long-term cooling of the jacket cooling. This can mean that the jacket cooling is maintained at a similar temperature throughout the year. If the jacket cooling would be better cooled in winter, this would only have a minor advantage which would be overcompensated for in summer by poorer cooling and thus a larger gap and a greater backflow. A cooling circuit coolant outlet temperature is a temperature of the coolant at an outlet from a primary and/or secondary circuit. Fundamentally, the heat absorption of all coolers connected to this primary or secondary cooling circuit can be derived as a cumulative result at this temperature. If the cooling circuit coolant outlet temperature is high, it can be expedient to actuate a corresponding recooler in such a way that the latter increases its cooling output. It is also considered to influence an overall coolant flow by the primary or secondary cooling circuit, in particular to adjust such a common coolant flow all the higher the higher the cooling circuit coolant outlet temperature.

In this way, the coolant outlet temperature can in particular be controlled in a closed loop to a desired value. The desired value for the coolant outlet temperature can be chosen in such a way that the operation runs as efficiently as possible. This can mean that little cooling water is consumed, for example in the case of freshwater cooling, or a predefined intake temperature, for example into so-called discharge wells or rivers, is adhered to, or the temperature is adapted for optimizing a cooling tower. A high coolant outlet temperature is often also desirable in order to achieve a utilizable temperature level, i.e. so as to be able to utilize the waste heat for other processes, for example for heating, adsorption refrigeration, drying processes, feed water pre-heating, etc.

In particular, the coolant heating can be controlled in a closed loop to a specific value.

It is proposed in particular to not only take into account one of the temperatures mentioned, but a plurality of such temperatures. In particular, at least one temperature is taken into account for each cooler used. Temperatures are preferably detected and evaluated at each cooler, so as to control the coolant flows as a function thereof. For example, if all of the coolant flows have an excessive temperature, it can be expedient to increase the overall coolant flow. If only individual temperatures are high, for example of the coolant flow of one cooler, whereas the temperature of the coolant flow of another cooler is low, in each case at the outlet, uneven cooling between the coolers considered is far more to be assumed. In this instance, the coolant flow with the high temperature can be increased, in order to mention an illustrative example. According to a further example, the entire coolant flow can be limited, or a predetermined water outlet temperature be predefined. In such cases, it is proposed not only to increase just the coolant flow through one cooler, but to simultaneously reduce the coolant flow through another cooler in order to keep a mixed overall outlet temperature constant.

In any case, it is proposed to carry out controlling at least as a function of one of the temperatures mentioned. It is proposed in particular to take into account a plurality of these temperatures, and it is proposed in particular to control at least one coolant flow or one overall coolant flow as a function of a plurality of the temperature mentioned, in particular as a function of two, three, four, five or even more of the temperatures mentioned. The common control installation can in particular be used for this purpose.

According to one aspect, it is proposed that the compressor installation is prepared in such a way that at least one coolant flow is controlled as a function of a pressure condensation point of the compressed gas. For this purpose, the pressure condensation point is in particular measured with a sensor system so that the pressure condensation point can be used for further processing in a control unit. It has been recognized in particular here that the absorption of moisture of the compressed gas can be controlled as a result. If the compressed gas, in particular the compressed air, cools down below its pressure condensation point, moisture can condensate, which may be undesirable; or else controlling can take place in a targeted manner in such a way that the pressure condensation point is reached. According to one design embodiment, the cooling installation, in particular one, a plurality of, or all coolant flows, is controlled in such a way that the compressed gas does not cool down below its pressure condensation point so as to avoid condensation of moisture from the compressed gas, in particular from the compressed air, as a result.

According to another, preferred design embodiment it is proposed that the compressed gas is cooled down to the extent that a downstream dryer reaches the desired condensation point, or slightly undershoots the latter, for example by 1 to 5 Kelvin. This is proposed for the following reason.

Prior to entering the dryer, the compressed gas is cooled as intensely as required in order to reach the desired condensation point, but also not unnecessarily to a greater extent. The objective here is that the compressed air has an ideally optimal temperature downstream of the dryer, i.e. is as warm as possible, but is not too warm, and is sufficiently dry.

Moreover, the available volumetric flow of coolant can be divided in such a way that the entire specific energy consumption is minimized. This means that the energy consumption at least of the compressor, the dryer and the cooling system becomes minimal in terms of the volumetric flow of compressed gas generated, or in terms of a mass flow of compressed gas.

Such controlling as a function of the pressure condensation point is proposed in particular when a drying installation is present. In this case, the cooling installation is controlled in such a way that the temperature of the compressed gas drops in such a way that the pressure condensation point is reached, or is almost reached prior to the compressed gas entering the drying installation.

The following example, based on an adsorption dryer, is intended to be used for highlighting this. Accordingly, a pressure condensation point of below −20° C. can be required. The dryer achieves this value only at an inlet temperature of the compressed air of below +50° C., wherein it is to be noted that this value may also depend on the pressure and on the regeneration temperature and on further variables. Thus, the compressed air is cooled from, for example, 200° C. to 50° C. so that the condensate is also generated and ideally completely separated in the process. Thereafter, a relative humidity of 100% may be present, and thus a pressure condensation point of 50° C. In this way, the dryer achieves a pressure condensation point of −20° C.

If more intense cooling takes place, for example to 30° C., the dryer then achieves a pressure condensation point of, for example, −35° C. The energy consumption of the dryer drops only slightly in the process. Therefore, it may be more efficient to use somewhat more cooling water for intercooling and jacket cooling, and to provide less water to the recooler for cooling purposes.

It can be achieved as a result that the compressed gas in the drying installation discharges moisture to the drying installation in an ideally easy manner, thus with an ideally minor input of energy. In particular, the pressure condensation point achievable in the dryer is all the lower the colder the compressed air at the inlet into the dryer was. As the inlet temperature into the dryer becomes colder, the moisture loading of the dryer can also be lower if a condensate separator and a condensate drain are installed ahead of the dryer.

Moreover, the following is to be noted in the context of a pressure condensation point, the latter also potentially being simply referred to as condensation point. The condensation point after the dryer can be decisive for downstream processes. It is considered to control in a closed loop the pressure condensation point after the dryer in the case of the refrigerant dryer as well as in the case of the adsorption dryer, thus at the outlet, or at the point of transfer to an application of the compressed gas, respectively, in that the temperature is adapted ahead of the dryer. Additionally, further measures which are described in DE 10 2014 019 805 B3 can be provided.

Nevertheless, in a closed-loop control cascade, the consequence of a pressure condensation point after the dryer is also an inlet temperature into the dryer. By virtue of a condensate separator ahead of the dryer, the pressure condensation point and the temperature here can be almost identical. For visualization, this can be explained in such a way that the condensation point is controlled in a closed loop ahead of the dryer, wherein however only the temperature ahead of the dryer is measured and not the condensation point ahead of the dryer, because a temperature measurement is substantially simpler.

According to one aspect, it is proposed that the compressor installation, in particular the cooling installation, is prepared in such a way that coolant flows are controlled in such a way that the overall coolant outlet temperature as the temperature of the coolant exiting the primary and/or secondary cooling circuit is controlled in a closed loop to a predefinable target outlet temperature. The primary cooling circuit and the secondary cooling circuit supply the connected coolers with cold coolant which is then heated in the respective cooler by the coolant flows, which are thus controlled in each case by a cooler. The coolant flows thus heated then converge again in the primary cooling circuit, or secondary cooling circuit, respectively, and form an overall coolant flow which exits the primary or secondary cooling circuit at a specific location. The temperature of the exiting coolant, thus the overall coolant outlet temperature, is detected at this outlet and it is thus determined by all the heating processes which the individual coolant flows have been subjected to by their respective cooler.

It can be particularly significant here that the overall coolant flow is reused, for example for heating, or that other requirements are set for the temperature of the outflowing overall coolant flow, for example for directing into a river.

On the other hand, an overall coolant outlet temperature which is too low indicates excessive cooling, the latter being undesirable because the recooler installation in this instance cannot cool down the excessive volumetric flow with an insufficient temperature difference to the desired temperature, or because the cooling water costs increase, in particular when fresh water is used, or the pump output and fan outputs increase along with associated costs. However, good intercooling and good jacket cooling would be helpful for the compressor. Good cooling after a second compressor stage would also be helpful for the dryer. However, unnecessarily intense cooling would be inefficient.

It has thus been recognized that it is advantageous to control in a closed loop the overall coolant outlet temperature to a predefinable target outlet temperature. It is ensured in particular as a result that sufficient cooling is present, and that efficient cooling is also present. Additionally, the waste heat can potentially be better utilized the higher the temperature level, thus the higher the overall coolant outlet temperature.

The compressor installation, or the cooling installation, are specified for controlling the coolant flows in that they have a corresponding control program that can receive the corresponding temperatures as measured values and as a function of the latter can emit control commands for controlling the respective control means. Such a control program can be implemented on a corresponding process computer of the compressor installation, in particular of the cooling installation, while the process computer possesses corresponding interfaces for receiving the required temperature values and for delivering the control values to be delivered.

Target values for closed-loop or open-loop controlling can be predefined by a superordinate control unit, specifically by the common control installation. In this way, the coolant outlet temperature of the overall coolant flow can be predefined for example by a heating controller as a function of an external temperature by way of a heating curve of the building to be heated.

According to one aspect, it is proposed that the compressor installation, in particular the cooling installation, is prepared in such a way that the coolant flow of the oil cooler by means of the respective control means is controlled in such a way that a predefined oil temperature is adjusted. It has been recognized in particular here that efficient operation can be achieved by adjusting the specific oil temperature, the latter being able to be correspondingly predefined. It can be achieved that the oil temperature does not become too high and the compressor thus does not overheat, but that said oil temperature also does not become too low, and the ideally optimal viscosity of the oil for lubricating the bearings and gear units is achieved, as a result of which the efficiency of cooling and/or of the compressor operation could deteriorate. In the case of excessively cold oil, the viscosity of the oil would be too high and the resistance, inter alia in the bearings, would be too high, which would lead to a higher energy consumption. Moreover, in the case of oil which is permanently too cold, the result can be an increased proportion of water in the oil, which would have a disadvantageous effect.

The compressor installation, or the cooling installation, can thus be prepared to control at least one coolant flow of a cooler for adjusting a corresponding temperature in such a way that a process computer is provided, on which a corresponding control unit is implemented. For this purpose, the process computer can possess input interfaces and output interfaces. Temperature values can be able to be received by way of the input interfaces, and control values can be able to be delivered by way of the output interfaces, in particular to the respective control means.

According to one aspect, it is proposed that the coolant flow of the at least one compressed gas cooler, in particular of the aftercooler, by means of the respective control means is controlled in such a way that a predefined compressed gas outlet temperature is not exceeded and/or not undershot. It is provided in particular here that the compressed gas does not become too hot, and this can be achieved by controlling the coolant flow of the corresponding compressed gas cooler. It is provided in particular that the coolant flow of the at least one compressed gas cooler, in particular of the aftercooler, is controlled in such a way that the compressed gas is not cooled more intensely than necessary.

Moreover or alternatively, it is proposed that the coolant flow of the at least one housing cooler, in particular of the jacket cooler, is controlled in such a way that a coolant outlet temperature of this coolant is lower than a coolant outlet temperature of one of the at least one compressed gas cooler, in particular of the intercooler. It has been recognized in particular here that a good distribution of cooling can be achieved as a result, and the two different coolers, specifically the housing cooler and the compressed gas cooler, can be mutually adapted. It is proposed in particular to optimally utilize the available cooling water, and to in particular minimize the specific output [kWh/m³]. The jacket cooling and the intercooling both have a relevant effect on the volumetric flow of compressed gas generated, and on the energy consumption, this being exploited herewith.

A low coolant outlet temperature of the coolant can fundamentally be achieved in that the coolant flow is increased. Thus, the coolant flow of the housing cooler here can be increased until the outlet temperature of the coolant flow is below the outlet temperature of the coolant of the intercooler. A correspondingly high cooling output is then achieved by way of the housing cooler, this also reducing the temperature of the compressed gas or of compressed gas that is at least partially compressed.

It has been recognized in particular here that the jacket cooling can have a major effect on the specific output. During optimal cooling of the housing, the housing assumes an optimal size so that the gaps become minimal. When the housing becomes warmer in relation to the rotors, because it is being cooled to a lesser extent, the gap between the rotors and the housing, or else the gap between the two rotors, becomes larger. As a result, more already compressed gas flows from one chamber back into the preceding chamber. As a result, the conveyed mass flow of gas is reduced, the energy consumption increases, and the gas becomes hotter.

The intercooling likewise has an effect on the specific output. The higher the temperature at the inlet of a second compressor stage, the higher also the corresponding intermediate pressure. The reason therefor lies in that the volumetric flow of the second compressor stage remains constant, but that this volumetric flow is only achieved at a higher pressure in the case of a higher gas temperature. The mass flow is already predefined by the first compressor stage.

It can thus be avoided that the first compressor stage would have to compress to a higher pressure than if intercooling were poorer.

According to one aspect it is proposed that the coolant flow of the at least one housing cooler, in particular of the jacket cooler, is controlled in such a way that a difference between the coolant outlet temperature when the coolant exits the housing cooler and a coolant inlet temperature when this coolant enters the housing cooler
is below a predeterminable first value and/or
is above a predeterminable second value, and/or
is between a predeterminable third and fourth value.

It has been recognized in particular to be advantageous here to provide programmed minimum hearting.

It has been recognized here that it can be positive in many cases to cool as well as possible, i.e. to convey through as much water as possible. However, it has also been recognized that this can however also have a limit from which this is no longer purposeful, because the extra complexity no longer has an appropriate benefit. As much cooling water as possible would be advantageous for the compression process of the gas, but would entail the cost of a lot of cooling water, or pump output.

In order to mention an illustrative example, when the volumetric flow of water for the jacket cooling is doubled, and the heating of the water is reduced from 40K to 20K in this way, this is in most instances purposeful and economical. However, in order to mention a further example, if the volumetric flow of water for the jacket cooling is doubled, and the heating of the water is reduced from 2K to 1K in this way, this is no longer very purposeful or economical, because the additional costs in terms of water, thus for cooling, exceed the savings in terms of gas, thus for the generation of compressed gas.

According to one aspect, closed-loop controlling to a minimum heating of the cooling water is implemented at least as a partial aspect in the case of one, a plurality of, or all heat exchangers. The greatest practical significance lies in the jacket cooling, but is also relevant in the remaining coolers, also in the oil cooler.

In many coolers, the closed-loop control to a minimum heating can intervene when unattainable gas temperatures are predefined, thus when it is predefined, for example, that a compressed gas temperature is lower than a coolant temperature of the overall coolant flow at the inlet of the latter.

A further reason for the closed-loop control to a minimum heating has been recognized in that an excessively large volumetric flow of water, or an excessive flow velocity, may lead to damage. However, in the absence of a measuring apparatus for the flow velocity, this can be evaluated by way of the temperature increase. As long as the minimum temperature increase is achieved, it can be ensured that the permissible maximum flow velocity is not exceeded even in the case of a maximum output.

Proposed according to the invention is also a method for operating a compressor installation. The compressor installation here comprises a compressor for compressing a gas for generating compressed gas, in particular compressed air, and a cooling installation, and the cooling installation comprises an oil cooler for cooling oil heated by the compressor, at least one compressed gas cooler for cooling the gas which is completely or partially compressed to the compressed gas, and at least one housing cooler for cooling a housing or part of the housing of the compressor, wherein the oil cooler, the at least one compressed gas cooler and the at least one housing cooler achieve cooling in each case by a coolant flow from a liquid coolant, in particular water, and wherein each coolant flow is individually controlled by an individual, actuatable control means in such a way that a cooling output is in each case controlled individually for the oil cooler, the at least one compressed gas cooler and the at least one housing cooler.

The method according to the invention thus uses a compressor installation having a compressor and a cooling installation, as has been explained above in the context of the aspects pertaining to a compressor installation having a compressor and a cooling installation. At least one compressor installation according to one of the aspects mentioned is used.

The method operates in such a way as has likewise been explained above in the context of the embodiments of the compressor installation. In particular the method steps for which the compressor installation, and the cooling installation, respectively, are prepared to carry out, are carried out according to the method according to the invention or according to aspects of the method according to the invention.

It is thus proposed in particular that the method according to the invention for operating a compressor installation uses a compressor installation according to at least one of the aspects described above.

The invention will be explained in more detail hereunder by way of example by means of embodiments with reference to the appended figures.

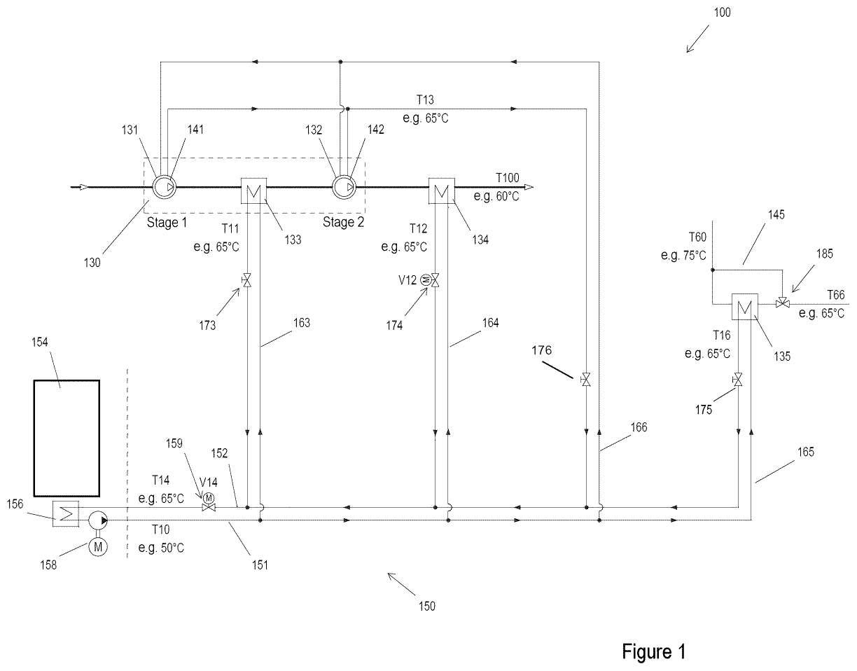

FIG. 1 shows a compressor installation according to the prior art in a schematic illustration,

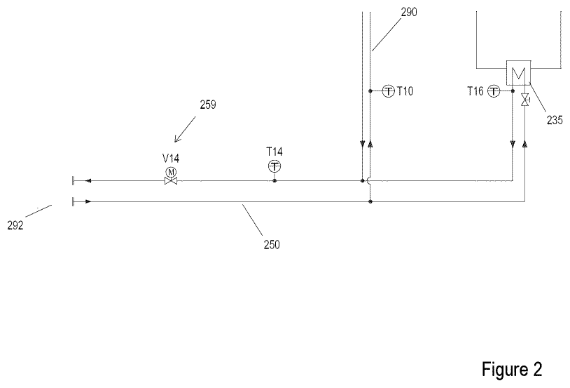

FIG. 2 shows a fragment of a compressor installation in a schematic installation,

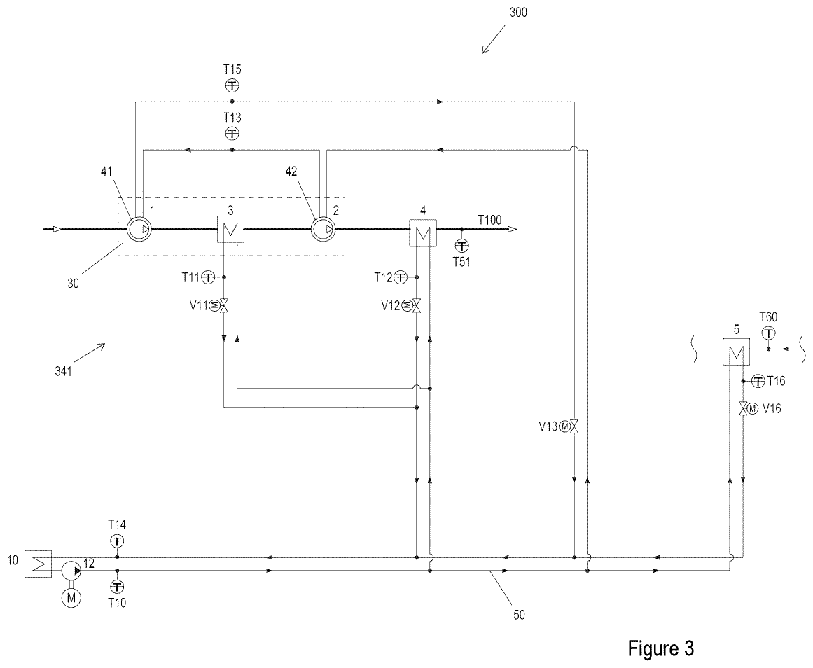

FIGS. 3 to 8 show in each case a compressor installation in each case according to an embodiment of the invention in a schematic illustration,

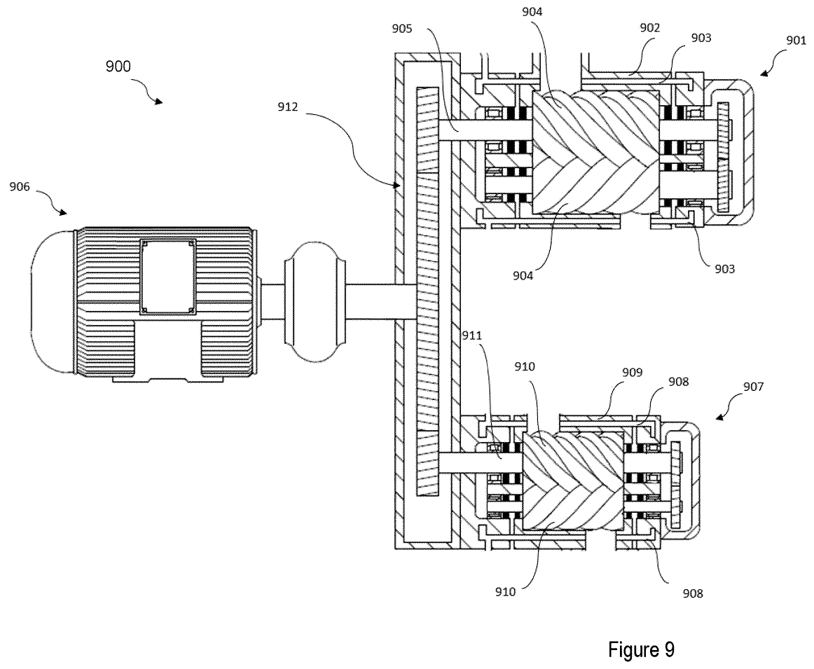

FIG. 9 shows a compressor installation having two compressor stages in a schematic, partially sectional illustration.

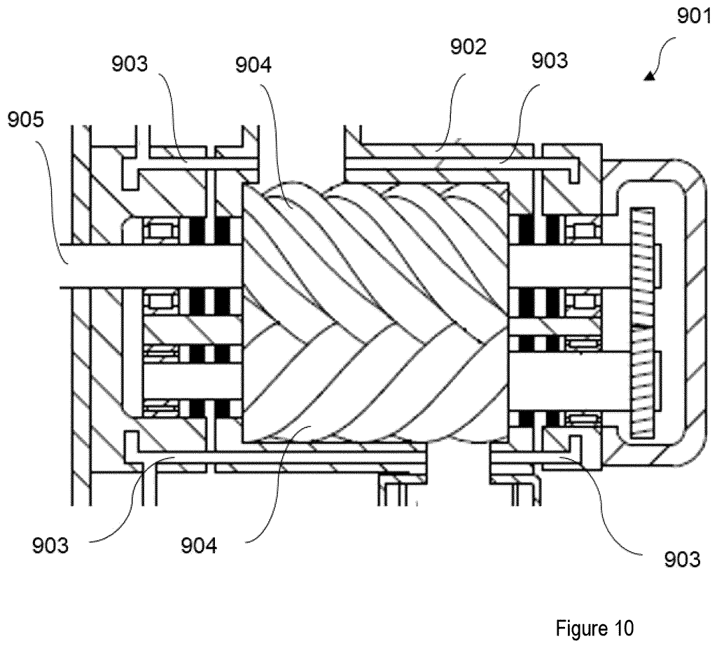

FIG. 10 shows a first compressor stage of the compressor installation of FIG. 9 in an enlarged illustration

FIG. 1 shows a compressor installation 100 having a compressor 130 having a first and second compressor stage 131 and 132, respectively. The compressor 130 and also the other elements are schematically illustrated.

Furthermore provided are an intercooler 133 and an aftercooler 134, which can also be referred to as compressed air intercooler and compressed air aftercooler, respectively. The intercooler here is illustrated as part of the compressor 130, because said intercooler is disposed between the first and second compressor stage; however, said intercooler can also be designed as a separate element. Accordingly, the aftercooler 134, which is not illustrated as part of the compressor 130, can be part of the compressor in another design embodiment.

Provided for cooling the first and second compressor stage 131, 132 are a first and second jacket cooling unit 141 and 142, respectively. The jacket cooling units 141 and 142 are in each case integrated in the compressor stage 131 and 132, respectively.

Moreover provided is an oil cooler 135. The oil cooler 135 is connected to an oil circuit 145 of the compressor 130. For improved clarity, the connection between the oil circuit 145 and the compressor 130 is not illustrated in the figure, and moreover also in most other figures.

A primary cooling circuit 150 having a coolant inflow 151 and a coolant backflow 152 is provided for cooling the compressor installation 100 overall. The coolers mentioned, specifically the intercooler 133, the aftercooler 134, the first and second jacket cooler 141, 142 and the oil cooler 135, are supplied with cold coolant, in the example illustrated specifically water, by way of this primary cooling circuit, specifically by way of the coolant inflow 151. The water, which is heated by the coolers in this way, by way of the coolant backflow 152, flows back into a heat sink 154 which is only indicated in an abstract manner. The heat sink 154 can, but no longer has to, be a constituent part of the compressor installation 100. A primary heat exchanger 156 is provided in the heat sink, or as the heat sink, respectively, and a common coolant flow in the primary cooling circuit 150 can be achieved by a primary coolant pump 158.

The coolers mentioned, specifically the intercooler 133, the aftercooler 134, first and second jacket cooler 141, 142 and the oil cooler 135 are connected in parallel in the primary cooling circuit. In this way, all the coolers mentioned are supplied by coolant from the primary cooling circuit 150. For this purpose, the respective coolers are connected in parallel to the primary coolant circuit by way of an intercooler strand 163, an aftercooler strand 164, a jacket cooler strand 166, and an oil cooler strand 165, respectively.

The jacket cooler strand 166 thus first supplies the first and second jacket cooler 141, 142. The first and second jacket cooler 141, 142 in the example according to FIG. 1 here are connected in parallel.

For setting the coolant flows, or their mutual ratios, manually adjustable valves are provided, specifically a manual intercooler valve 173, a manual jacket cooler valve 176 and a manual oil cooler valve 175. An aftercooler adjustment valve 174 is provided in order to be able to better mutually adapt the intercooler 133 and the aftercooler 134.

Furthermore provided is a primary adjustment valve 159 which can control the backflow of the overall coolant in the coolant backflow.

Moreover provided is also an oil bypass valve 185 by way of which the flow of oil through the oil cooler 135 can be controlled.

FIG. 1 thus shows a functioning cooling concept for which improvements have, however, also been recognized. It has been demonstrated in particular that the individual coolers are at least partially not well mutually adapted and cool to different extents relative to one another. It has been recognized that there exists a demand for improvements here, in order to achieve positive, uniform and thus efficient cooling for the compressor installation 100. It has likewise been recognized that there is a demand for adapted cooling for each cooler, which can also be a function of the operating state of the compressor installation, in particular of the cooling installation of the latter. A demand for adapted cooling can in particular be a function of the final pressure, a function of the rotating speed, a function of the intake temperature, a function of the cooling water inlet temperature T10, a function of a desired cooling water outlet temperature at the temperature measuring point T14.

It is to be noted that the compressor installation 100 thus consists of the compressor 130 and the many coolers mentioned and also including the primary cooling circuit, wherein the coolers mentioned including the primary cooling circuit (optionally additional secondary cooling circuit) can be understood to be a cooling installation of the compressor installation.

This results in particular in the following disadvantages:

Dividing the volumetric flows of water among the parallel coolers had to be adjusted manually, but the distribution of the heat outputs and thus the water temperatures can fluctuate significantly as a function of the operating point.

At a higher desired outlet temperature at the temperature measuring point T14, the oil cooler and the jacket cooling have to be cooled separately with cooling water, which may take place by way of a secondary cooling system.

Due to various interference variables, there may be significant deviations between the individual outlet temperatures T11, T12, T13, T16.

In most instances, ineffective utilization of the cooling water is the result. Damage to stages by excessively cold cooling water is possible.

Likewise, the following has been established as disadvantageous.

The water outlet temperature was controlled in a closed loop by way of a common valve V14.

The oil temperature was controlled in a closed loop by way of a bypass to the oil cooler. The oil cooler received an unnecessarily large amount of water in most instances, so that the latter can still cool to a sufficient extent even in the worst case.

The aftercooler received an unnecessarily large amount of water in most instances, so that the latter can still cool to a sufficient extent even in the worst case. Only the temperatures T11=T12 were balanced by way of the valve V12 in order to be able to compensate for different heat outputs in the aftercooler.

The jacket cooling receives too little water in most instances in order to be able to achieve the desired outlet temperature T14—or else sometimes too much water and water that is too cold, which can lead to damage to the stages.

The intercooling only receives sufficient water in order to be able to achieve the desired mixed outlet temperature T14.

Should one component temporarily require better cooling, V14 opens to a greater degree so that all heat exchangers receive more water, but the desired water outlet temperature T14 no longer is achieved.

FIG. 2 shows a fragment of a compressor installation having the primary cooling circuit 250, which can fundamentally correspond to the primary cooling circuit 150 of FIG. 1. FIG. 2 visualizes in particular the primary cooling circuit 250. The latter can be controlled by way of the primary adjustment valve 259, which may correspond to the primary adjustment valve 159 of FIG. 1, in order to supply the connected coolers with coolant. The flow rate through the primary cooling circuit 250 can be controlled by way of the primary adjustment valve 259. As a result, various connected coolers, in particular various connected heat exchangers, are also controlled. In particular, the oil cooler 235, which is designed as a heat exchanger, is supplied here with the coolant by the primary cooling circuit 250. Likewise provided is a parallel strand 290 which is connected in parallel to the cooling portion, which supplies the oil cooler 235, and can in particular supply the other coolers mentioned in the context of FIG. 1, which thus can supply in particular the intercooler 133, the aftercooler 134 and the first and second jacket cooler 141, 142.

The primary cooling circuit 250 can be connected to a heat sink, as illustrated in FIG. 1, by way of an interface 292.

With reference to FIG. 2, in the case of the dry-running units, there was thus to date a control valve V14 in the primary circuit 250, which conjointly controls the flow rate through a plurality of parallel heat exchangers.

There were only manual valves in order to adjust the distribution of the flow rates.

Only the heat exchanger for stage 2 already had a dedicated control valve, because the deviations are at a maximum here.

FIG. 3 shows a compressor installation 300 according to one design embodiment. This compressor installation 300, in a manner very similar to the compressor installation 100 of FIG. 1, has a compressor 30 having a first and second compressor stage 1, 2 having a first and second jacket cooler 41, 42. In the embodiment shown, the first and second jacket cooler 41, 42 are mutually connected in series.

Moreover provided are an intercooler 3 and an aftercooler 4, each cooling compressed gas. The intercooler 3 here cools a compressed gas that is partially compressed, while the aftercooler 4 cools the compressed gas that is completely compressed.

Likewise provided is an oil cooler 5 which cools oil that flows through the compressor 30.

All the coolers 3, 4, 5, 41 and 42 mentioned are connected to a primary cooling circuit 50, the latter thus supplying the former with coolant. Provided for operating the primary cooling circuit are a primary heat exchanger 10 and a primary coolant pump 12—similar to what is also shown in FIG. 1. The primary heat exchanger 10 and/or the primary coolant pump 12 can in each case form part of the compressor installation, or else not.

It is now provided according to the invention that each of the cooling elements connected to the primary cooling circuit 50 can be controlled by way of a dedicated, specifically individual, control means in a nonmanual manner, in particular by way of actuatable control means. Provided for this purpose are in each case adjustment valves V11, V12, V13 and V16 which are in each case disposed in a coolant strand that is connected in parallel to the primary cooling circuit, so as to control a coolant flow through the respective cooling element. Adjustment valves, in this embodiment and all other embodiments, can simply be referred to as valves. Coolers connected in series are thus in each case combined to form one cooling element. The intercooler 3, the aftercooler 4 and the oil cooler 5 thus form in each case one cooling element. The first and second jacket cooler 41 and 42 are thus combined to form a common jacket cooler 341, the latter thus forming one cooling element and being actuated by way of the adjustment valve V13. Alternatively, separate valves would also be possible.

The cooling elements mentioned, thus intercooler 3, aftercooler 4, oil cooler 5 and jacket cooler 341, can thus be individually actuated, and an adapted cooling concept for the compressor installation 300 can be achieved as a result.

It is in particular provided to also detect and take into account temperatures of the coolant, thus of the cooling water, for controlling the respective cooling elements, or for this purpose for controlling the adjustment valves V11 to V13 and V16. Corresponding temperature measuring points T10 to T16 are provided therefor. As a result, the cooling units can be mutually adapted, and this can take place by means of the corresponding temperatures of the cooling flows, including the overall coolant flow of the primary cooling circuit 50.

Additionally, other temperatures can also be detected, and for this purpose an oil temperature is detected by the temperature measuring point T60 in the embodiment of FIG. 3. Additional temperatures can also be detected, in particular at least one temperature of the compressed gas, this being indicated by the temperature measuring point T51. In this figure, T100 here represents the same outlet temperature from the compressor installation, for which T51 is also provided. However, temperatures of the compressed gas can also be detected at other locations, including at locations where complete compression has not yet taken place, in particular between the first and second compressor stage 1, 2, or else ahead of the first compressor stage 1.

All these temperatures can preferably be included in the control of the cooling, and thus control of the adjustment valves V11 to V13 and V16. However, it is not necessary for all temperatures to be taken into account. At least one temperature is preferably taken into account.

The compressor installation according to FIG. 3 thus has a compressed air intercooler 3, a compressed air aftercooler 4, oil cooler 5 as well as stages 1, 2 having jacket cooling 41, 42.

In this exemplary embodiment, there is a cooling water circuit 50 which has a heat exchanger 10, for example for heat recovery. The heat exchanger 10 can be used for utilizing waste heat; however, a cooling system which is not used for utilizing waste heat may also be used.

However, the benefit is particularly great in combination with utilization of waste heat.

The volumetric flow of water through the components 3, 4, 5, 1, 2, or 41, 42, respectively, can be adjusted individually and in an optimized manner by way of the four control valves V11, V12, V13, and V16.

Closed-loop control of the (mixed) water outlet temperature T14 of the compressor is possible by way of the above-mentioned valves V11, V12, V13, V16.

It is proposed in particular that the temperatures after the first and second compressor stage, thus at the measuring points T11 and T12 according to the figures, are included in order to preclude vapor lock and associated risks.

It is proposed to include at least one oil temperature, for example at the measuring point T60, in the control, so as to control in a closed loop the volumetric flow of water through the oil cooler. Alternatively, a component temperature, for example a bearing outer ring temperature, could be used.

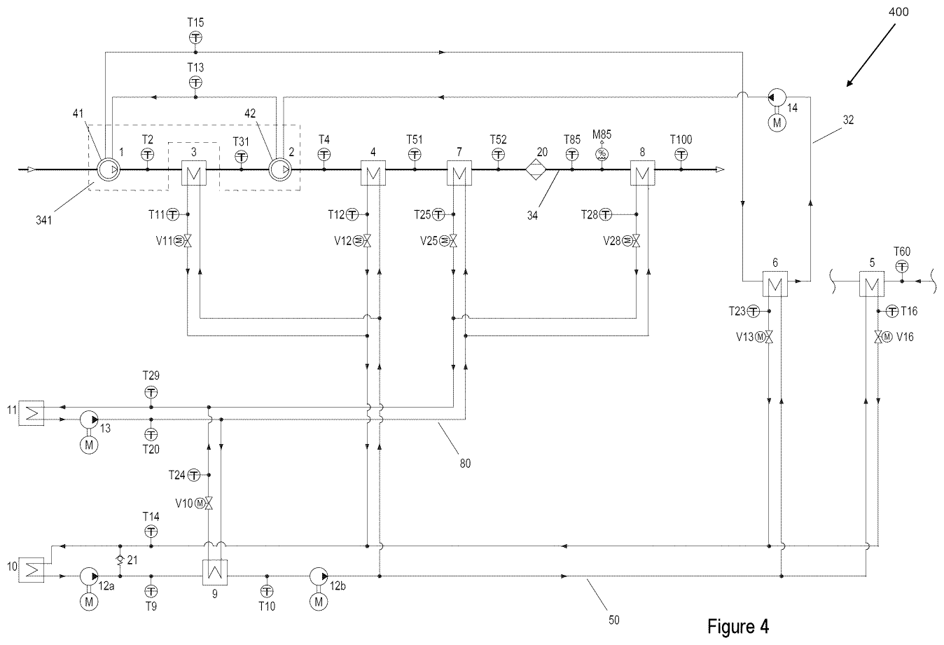

It is particularly preferably proposed to include an inlet temperature of the compressed gas into the second compressor stage, thus particularly at the measuring point T31 shown in FIG. 4, in the control, so as to protect the second compressor stage from excessive temperature.

It is particularly preferably proposed to include the outlet temperatures of the coolant when exiting the jacket cooler of the second, or first compressor stage, respectively, in the control, thus the temperatures at the measuring points T13 and T15 according to the corresponding figures. This is proposed in order to preclude vapor lock.

It is preferably proposed to include an outlet temperature of the compressed gas when exiting the compressor installation in the control. This may be the temperature at the measuring point T100 according to the corresponding figures. It is proposed that these temperatures are included in the individual closed-loop control and optimization.

A mixed water outlet temperature, thus the outlet temperature of the overall coolant flow, specifically the temperature at the measuring point T14 according to the corresponding figures, has been recognized as relevant, and it is proposed to include this outlet temperature in the control.

The temperatures at the measuring points T100, T14 and T60 have likewise been recognized as relevant. Particularly preferably, they are included in the control.

It has moreover been recognized that at least one temperature sensor, in particular a corresponding measuring point, for each valve is advantageous for the closed-loop control. It is thus proposed to provide these temperature sensors and to in particular include them in the control.

For controlling the valve V11 it is proposed to use at least one, a plurality of, or all temperatures of the measuring points T14, T11 and/or T31. Moreover, temperatures of at least one of the measuring points T2 and T4, T12 and T10, and optionally additional measuring points, can preferably be used.

For controlling the valve V12 it is proposed to use at least one, a plurality of, or all temperatures of the measuring points T100, T14, T12 and/or T51. Moreover, temperatures of at least one of the measuring points shown in FIG. 4, or the temperatures T52 and T85 and M85, and optionally additional measuring points, or additional temperatures, can preferably be used.

For controlling the valve V13 it is proposed to use at least one, a plurality of, or all temperatures of the measuring points T13, T15 and/or T23 which are partially shown in FIG. 4. Moreover, temperatures of at least one of the measuring points T2 and T4, T14 or T29, and T10 or T20, which are partially shown in FIG. 4, and optionally additional measuring points, can preferably be used.

For controlling the valve V16 it is proposed to use at least one oil temperature, in particular at least one of the temperature measuring points T60 and/or T66, which are partially shown in FIG. 1. Moreover or alternatively, at least one characteristic component temperature, for example a bearing temperature, can also be used. Moreover, temperatures of the measuring points T16, T14 or T29, and T10 or T20, which are partially shown in FIG. 4, and optionally further temperatures, or temperatures of additional measuring points, can preferably be used.

The following figures describe other embodiments; for the sake of improved clarity, identical reference signs pertaining to the embodiment of FIG. 3 are however partially used in order to better demonstrate context. For this purpose, it is not mandatory, however, that the elements are actually identical. For example, if a third or fourth compressed gas cooler is added to the intercooler and aftercooler, it is considered that the intercooler and aftercooler might be correspondingly of a smaller dimension. Nevertheless, for the sake of improved clarity, the same reference signs, specifically 3 and 4, are also used in each case for the intercooler and aftercooler in the following embodiments.

FIG. 4 shows an embodiment of a compressor installation 400 which provides a jacket cooler heat exchanger 6, which can simply also be referred to as a heat exchanger, for the first and second jacket cooler 41, 42. The jacket coolers 41, 42 here are also connected in series, but a coolant flow through the jacket coolers 41, 42 is driven by a jacket cooler pump 14 and thus drives a dedicated cooling circuit which can be referred to as a compressor cooling circuit, because the coolant flows through corresponding jacket regions in the first and second compressor 1, 2, respectively. The jacket cooler pump 14 is thus a cooling water pump for the compressor cooling circuit 32. This compressor cooling circuit 32 is directed through the heat exchanger 6, specifically through a primary side of the jacket cooler heat exchanger 6. Coolant from the primary cooling circuit 50 flows through the secondary side of the jacket cooler heat exchanger 6. The corresponding coolant flow from the primary cooling circuit 50 through the jacket cooler heat exchanger 6 is controlled by the adjustment valve V13.

The valve V13 is preferably actuated as a function of the temperatures T13 and/or T15. This then results in the temperature T23. Temperatures at measuring points Txx can hereunder and above also be simply and synonymously referred to as temperatures Txx.

The temperatures T13 and/or T15 are considered to be more relevant in comparison to T23. However, T23 could alternatively be used.

The risk of vapor lock exists at the temperature measuring point T13 as well as at the temperature measuring point T15. It is therefore proposed to measure these temperatures there.

During a cold start, V13 remains closed so that there is no coolant flow at T23. In this instance, there is also no increasing temperature resulting at the temperature measuring point T23.

The temperature measuring points T13 and T15 are preferably placed directly on an outlet at a higher level. As a result, temperature increases can also be detected without active recirculation, so as to initially start a jacket cooler pump depending thereon. This then results in a forced flow at the temperature measuring points T13 and T15, and thus in a positive temperature measurement. However, the valve V13 can continue to be closed, so that no measurement and thus no closed-loop control is possible here for this duration. When the temperatures T13 and/or T15 continue to increase, the valve V13 is opened by the control unit, which can also be referred to as “opened by closed-loop control”. It is only then that the temperature at the measuring point T23 could be used for the closed-loop control.

The adjustment valve V13 can be referred to as a jacket cooler adjustment valve, and it controls the coolant flow through the jacket cooler heat exchanger 6. The valve V13 controls the volumetric flow of coolant for the jacket cooling heat exchanger 6. In other design embodiments, said valve can also control the volumetric flow of coolant for the jacket coolers 41, 42. The valve V13 controls the temperatures T13 and T15, and optionally additional ones, for the jacket cooler/coolers. The volumetric flow for the jacket cooling 41, 42 in the design embodiment of this FIG. 4 is controlled by the jacket cooling pump 14.

FIG. 4 moreover has a second and third aftercooler 7, 8 which can also be referred to as second and third compressed air aftercooler or compressed gas aftercooler, or which simply can be referred to as heat exchanger because they are preferably implemented as heat exchangers. They are disposed in a compressed gas line 34, specifically downstream of the compressed gas, behind the aftercooler 4, or compressed gas aftercooler 4. As a result, additional cooling of the compressed gas can be achieved.

As is also shown by the embodiment of FIG. 4, it is particularly preferable to use a dryer for the compressed gas, in particular an adsorption dryer 20, which is incorporated in the compressed gas line 34. In the case of a refrigeration dryer, an additional aftercooler is likewise purposeful, in order to control in a closed loop the condensation point and the outlet temperature by way of said aftercooler. However, in the case of the refrigeration dryer, as illustrated, the dryer aftercooler 8 is less purposeful. In the case of the refrigeration dryer, the heat exchanger 8 could rather be used for heating the compressed air. Therefore, the use of an adsorption dryer is in particular proposed here. In the case of the adsorption dryer, the heat exchanger 8 is used particularly for cooling the compressed air.

It is proposed in particular here that the compressed gas dryer 20 in the flow direction of the compressed gas is disposed behind the second aftercooler 7 and ahead of the third aftercooler 8.

An adjustment valve V25 and V28 is in each case provided for controlling a coolant flow through the second aftercooler 7 as well as through the third aftercooler 8, respectively. In this way, the second and third aftercooler 7, 8 per se can be controlled independently of one another.

A temperature measuring point T25 and T28 is additionally provided in each case and assigned to the second and third aftercooler 7, 8, respectively, and thus to the corresponding adjustment valve V25 and V28, respectively.

It has been recognized in particular here that the dryer can be supported by the second heat exchanger 7, and the pressure condensation point after the dryer can be influenced in this way. As a result, the outlet temperature from the dryer is, however, also reduced, which is sometimes desirable, but is sometimes also undesirable.

By way of the heat exchanger after the dryer, the compressed air can be brought to the optimal temperature for the downstream application. In the case of an adsorption dryer, the air at the outset can be significantly warmer than at the inlet, so that renewed cooling may be required here.

The adjustment valve V25, which controls the coolant flow through the second aftercooler 7, can control this coolant flow as a function of the temperature detected by the temperature measuring point T25. However, the air outlet temperature T52 is preferably controlled in a closed loop by the valve V25. The target value for this temperature T52 in plants with a dryer is derived by a closed-loop control cascade from the desired pressure condensation point after the dryer. In plants without a dryer, the target value for the temperature T52 is derived from the target value for the temperature T100 which can be externally predefined.

Closed-loop controlling after the temperature T25, or after a temperature difference T25-T20, is also possible according to an additional design embodiment.

The adjustment valve V25 thus controls the coolant flow as a function of the outlet temperature of the compressed air at the temperature measuring point T52 from the second aftercooler 7.

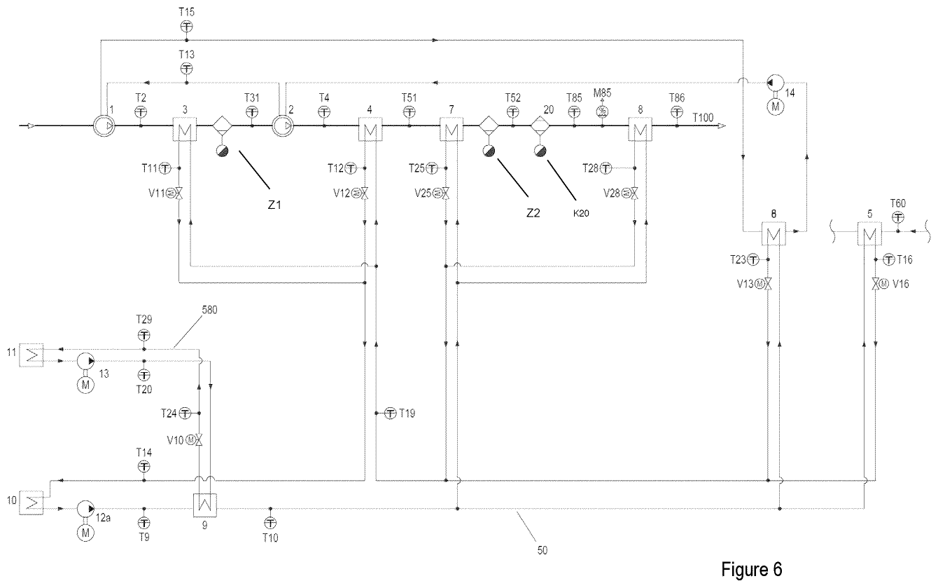

It is likewise provided that the adjustment valve V28, which controls the coolant flow through the third aftercooler 8, controls in a closed loop the compressed air outlet temperature T86, or T100, shown in FIG. 6. Closed-loop controlling after the temperature T28, or the differential temperature T28-T20 is provided according to an alternative design embodiment.

Thus, this can take place as a function of the temperature of the temperature measuring point T28; it is also possible to control the coolant flow as a function of the coolant temperature at the outlet of the third aftercooler 8.

A secondary cooling circuit 80 is provided for the second and third aftercooler 7 and 8 for supplying with coolant.

The secondary coolant circuit 80 can discharge heat again by way of a secondary heat exchanger 11, and its coolant flow can be driven by way of a secondary coolant pump 13. Largely independent cooling by the second and third aftercooler 7 and 8 is possible by this secondary cooling circuit, specifically independently of the other coolers, and independently of the primary cooling circuit.

In the embodiment shown, it is additionally provided that the secondary coolant circuit 80 cools a coolant flow, in particular overall coolant flow, of the primary cooling circuit, and provided for this purpose is a corresponding primary/secondary heat exchanger 9. Moreover, the adjustment valve V10 is provided for actuation, which is thus disposed in a coolant strand of the primary/secondary heat exchanger 9. The actuation of the adjustment valve V10 can take place as a function of a coast-down temperature of the coolant leaving the primary/secondary heat exchanger 9. A temperature measuring point T10 is provided for this purpose. The temperature of the coolant flowing through the adjustment valve V10 can be detected at the temperature measuring point T24.

It is likewise proposed to split the primary coolant pump 12 according to FIG. 3 into the embodiment shown in FIG. 4, thus to provide two primary coolant pumps 12a and 12b instead, specifically one before and the other after the primary/secondary heat exchanger 9. Moreover, a primary circuit bypass 21 can be provided, by way of which part of the overall coolant flow of the primary cooling circuit 50 flows past the primary heat exchanger 10. As a result of the internal pump 12b, interacting with the bypass 21 and the heat exchanger 9, the operation of the compressor and thus of the compressed air supply can be maintained even when the external heat sink 10 and/or the pump 12a are/is not available. This may be the case, for example, during maintenance work or conversion measures, or even during a seasonal heat demand.

The external pump 12a is in particular conceived for the external pressure losses, specifically in the heat exchanger 10 and in pipelines and optionally additional elements. The internal pump 12b can run conjointly for support, or else only be on standby for use when needed. Said internal pump is only switched on when the primary coolant pump 12a does not deliver, or delivers an insufficient amount of water, and the compressor would otherwise become too hot, and this would lead to a shutdown.

Moreover, a pressure condensation point temperature measuring point M85 is provided after the drying installation 20. In this way, the pressure condensation point temperature is determined at that location, and the cooling can be controlled as a function thereof. It is proposed in particular to control the second aftercooler 7 and/or the valves V25 and/or V28 as a function of the pressure condensation point temperature.

The pressure condensation point after the dryer is particularly relevant. At the inlet of the dryer, the compressed air is in most instances saturated by 100%. Therefore, the temperature and the pressure condensation point here are almost identical, assuming that the separated condensate has been ideally completely removed and discharged ahead of the dryer.

The temperature of the compressed gas at the inlet into the dryer is particularly important for the drying result.

If the condensate were not to be removed in front of the dryer, the drying result would worsen somewhat. However, the compressor should be conceived in such a way that the condensate already separated has already been removed beforehand.

The condensate separator and discharger have not been illustrated in the images partially for reasons of simplification.

Nevertheless, it is provided in the embodiment of FIG. 4 to record a few additional temperatures in comparison to the embodiment of FIG. 3. Provided therefor are overall the temperature measuring points T1 to T100, to the extent that they are plotted in FIG. 4.

Hereunder is in particular a summary of some substantial aspects of the embodiment according to FIG. 4.

The compressor installation according to FIG. 4 thus has another two additional coolers 7, 8.

In this embodiment, there are two cooling water circuits 50, 60 among which the coolers and the jacket cooling are distributed.

The secondary circuit 80 can possess a cooling tower 11 for discharging heat, in order to mention one preferred example.

The volumetric flow of water through the additional coolers 7, 8 can also be adjusted individually and in an optimal manner by way of the two control valves V25 and V28.

When adjusting the valves, the measured pressure condensation point M85 is also taken into account here so that the latter is optimized. The valves V25 and V12 can be actuated for adjusting the pressure condensation point.

The outlet temperature T100 is used in particular for actuating the valve V28. The temperature T100 is also influenced by the valves V25 and V12.

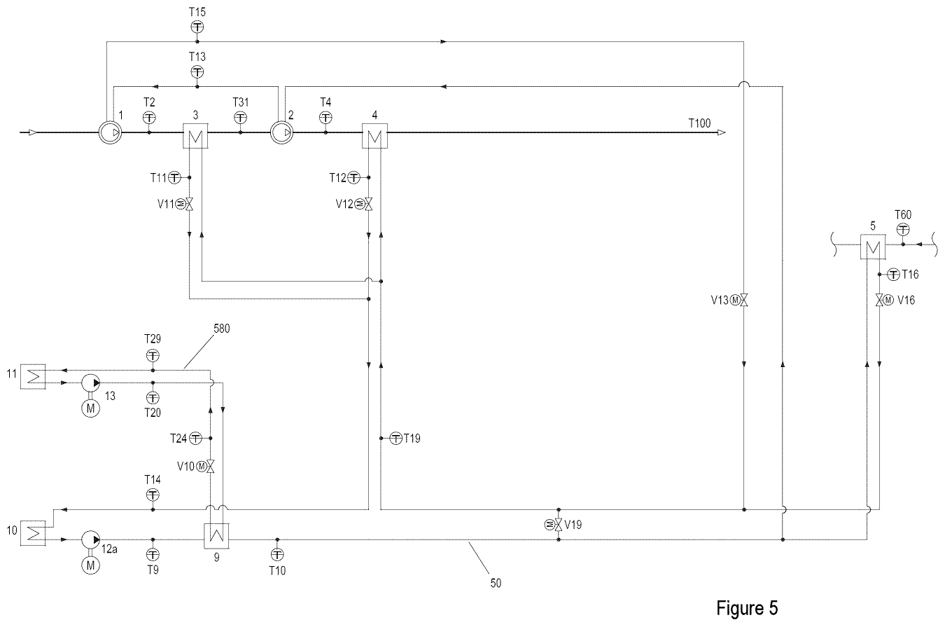

The embodiment of FIG. 5 again proceeds from the embodiment according to FIG. 3 and additionally provides a secondary cooling circuit 580, the latter however being provided exclusively for cooling the overall coolant flow of the primary cooling circuit 50. To this extent, the design embodiment of the secondary cooling circuit 580 corresponds to that of the secondary cooling circuit 80 of FIG. 4, in particular in terms of its link-up by way of the primary/secondary heat exchanger 9.

A primary bypass 21, as shown in FIG. 4, is not provided in the embodiment according to FIG. 5, but it is nevertheless considered to use such a primary bypass here too.

The embodiment of FIG. 5 additionally provides a primary bypass adjustment valve V19 which can simply also be referred to as the bypass valve V19 and by way of which part of the overall coolant flow of the primary coolant circuit 50, before being tapped—also after being tapped according to one embodiment—by the first and second jacket cooler 1, 2 and the oil cooler 5 can be supplied to the intercooler 3 and aftercooler 4. To this extent, the embodiment of FIG. 5 also differs from that of FIG. 3 and also of FIG. 4, in that the intercooler 3 and the aftercooler 4 can receive part of the cooling flow that has not yet been heated by the oil cooler 5 and the first and second jacket cooler 41 and 42 directly only by way of this primary bypass adjustment valve V19. In this embodiment of FIG. 4, it is specifically the case that the heat absorbed by the coolant in the oil cooler 5 and in the first and second jacket cooler 41 and 42 is also directed through one of the two compressed gas coolers, thus the intercooler 3 or the aftercooler 4, unless part of the coolant flow has been directed past the latter two by the primary bypass adjustment valve V19.

This is proposed as an optimized circuit arrangement for utilizing waste heat at a high temperature level. The oil cooler and the jacket cooling here receive a maximum volumetric flow with primary water which has not yet been pre-heated and has the temperature T10.

The primary bypass adjustment valve V19 is used in particular during a cold start. When the oil has not yet reached the operating temperature, the primary bypass adjustment valve V19 is closed. In the case of a coolant which is still cold, thus cold water particularly with low temperatures at the temperature measuring points T10, T13, T15, the adjustment valve V13 can also be closed. However, it has been recognized that the valves V11 and V12 should control a sufficient water flow rate already very quickly after the cold start. Therefore, it is proposed to open the valve V19 during the cold start. During operation, once the cold start procedure has been completed, it is proposed to close the bypass valve V19 somewhat again so that the oil cooler and the jacket cooling can receive a relatively high volumetric flow of cooling water.

A predefined water outlet temperature, thus target temperature, at the measuring point T14 can only be obtained from a mixture of the coolant sub-flows with the temperatures T11 and T12. Higher outlet temperatures can be achieved at these two coolers. In particular, a high outlet temperature T14 can be achieved as a result.

It has been recognized that the following advantages result.

The waste heat from the oil cooler and from the jacket cooling can be provided for utilizing the waste heat, even at water temperatures at which this has not been possible to date.

A higher target temperature for the outlet temperature T14 can be achieved, because only the partial coolants with the temperatures T11 and T12, or at the measuring points T11 and T12, are mixed, which results in a mixing temperature which is not reduced by mixing with coolants with the temperatures T16 and T15.

In this way, high temperatures and simultaneously high outputs, for which a hot water system would otherwise be required, can be achieved with a water system.

Hereunder is a summary of some substantial aspects of the embodiment according to FIG. 5. The embodiment of FIG. 5 thus has no additional cooler.

There are again two cooling water circuits 50, 580 here.

The coolers 3, 4, 5 and the jacket cooling of stages 1, 2 are located in the primary circuit 50. First, there is presently here a parallel connection of the oil cooler 5 and the jacket cooling of stages 1, 2. Thereafter, the intercooler 3 and the aftercooler 4 are connected in series. The latter two are likewise mutually connected in parallel.

The secondary circuit 580 here cools the primary circuit 50 when required.

This variant of circuit arrangement affords particular advantages in the heat recovery by way of the heat exchanger 10, which can also be referred to as waste heat utilization.

The embodiment according to FIG. 6 corresponds to that of FIG. 4, except for the deviations that the second aftercooler 7 and third aftercooler 8 are connected to the primary cooling circuit 50 in a parallel connection. A secondary cooling circuit 580 is likewise provided, which is designed as in FIG. 5 and is coupled to the primary cooling circuit 50.

The intercooler 3 and aftercooler 4, which in this embodiment and the other embodiments can synonymously also be referred to as the first aftercooler 4, are connected to the primary cooling circuit 50 not in a parallel connection, but in a series connection, similar to the embodiment of FIG. 5, in which they are supplied with the coolant from the primary cooling circuit 50 once said coolant has passed through the other coolers. A primary bypass adjustment valve V19, as shown in FIG. 5, can be dispensed with here, because a sufficient volumetric flow of water always flows particularly through the second aftercooler 7 conjointly with the adjustment valve V25, so that the intercooler 3 and the aftercooler 4 downstream in series can always receive a sufficient volumetric flow.

The temperature measuring point T86 is provided for detecting the temperature T100 of the compressed gas at the outlet of the compressor installation. In each case one separator Z1 and Z2, which can in particular be designed as a cyclone separator, and a condensate drain K₂O, are likewise illustrated in FIG. 6. They can likewise be present in the other embodiments, even when not shown.

Hereunder is a summary of a few substantial aspects of the embodiment according to FIG. 6. Additional coolers 7, 8 are thus present in this embodiment of FIG. 6.

There are again two cooling water circuits 50 and 580 here.

The coolers 3, 4, 5, 7, 8 and the cooler 6 for the stages 1, 2 are located in the primary circuit 50. First, there is presently here a parallel connection of the oil cooler 5 of the cooler 6 for the stages 1, 2 and the additional coolers 7, 8. Thereafter, the intercooler 3 and the aftercooler 4 are connected in series. The two latter are likewise mutually connected in parallel.

The secondary circuit 580 here cools the primary circuit 50 when required.

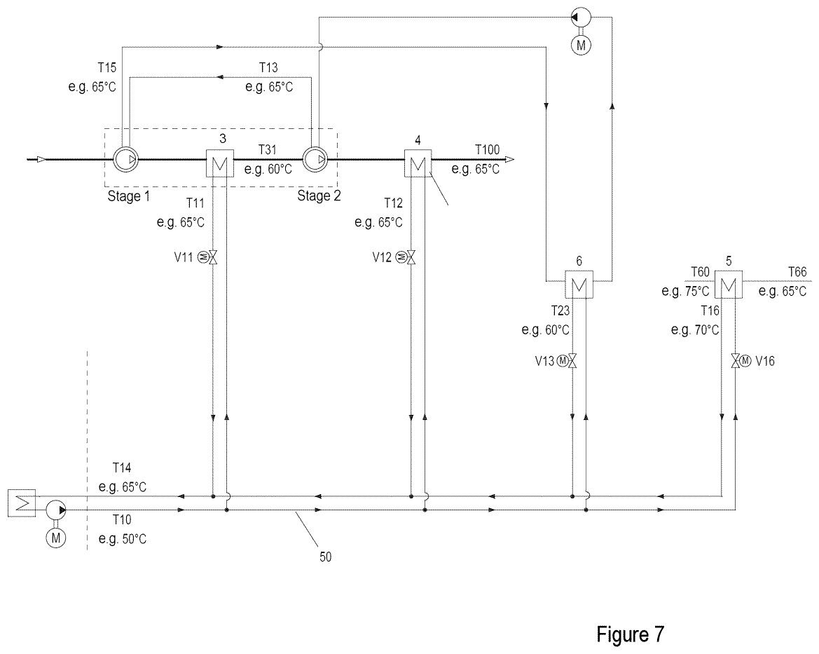

The embodiment of FIG. 7 corresponds substantially to the construction of FIG. 3. The former however differs in that it provides a jacket cooler heat exchanger 6 for the first jacket cooler 41 and the second jacket cooler 42, i.e, thus the jacket cooler 341. The construction and the cooling connection in terms of the jacket cooling by means of the jacket cooler heat exchanger 6 is implemented as illustrated in FIG. 6.

Moreover, the intercooler 3 and the aftercooler 4 in FIG. 7 are in each case connected independently to the primary cooling circuit 50 in a parallel connection. However, this results in FIG. 7, like in FIG. 3, in a parallel connection of the intercooler 3 and of the aftercooler 4 relative to the primary circuit, and this highlighted difference between FIGS. 3 and 7 is substantially of a constructive nature.

The following advantages result for the embodiment of FIG. 7, or else for the other embodiments.

Improvement of the specific output by approx . . . 1 . . . 3% due to better jacket cooling and intercooling.

Higher heat recovery output possible, and optionally lower/no cooling water requirement.

Closed-loop controlling to a higher water outlet temperature T14, thus the possibility of predefining a higher target value for this water outlet temperature T14, specifically higher than to date is possible. (e.g. 90° C. . . . 95° C., instead of ˜85° C., as to date.)

A higher operational reliability is achievable because the compressor can be better cooled in a targeted manner when required.

Easier start-up is possible, because no manual balancing of the strand control valves is required.

Water distribution is in particular automatically adapted in a seasonal, weather-dependent, final pressure-dependent, rotating speed-dependent manner.

An efficient use of the cooling water is possible.

Lower compressed air consumption by optimal compressed air temperature can be achieved.

The following additional advantages result.

Optimized closed-loop control of the mixed water outlet temperature T14 with a separate closed-loop volumetric flow control per heat source is possible.

The user can predefine a water outlet temperature T14, a maximum compressed air outlet temperature T100 and optionally a maximum pressure condensation point.

The oil cooler always receives only as much water as necessary in order to achieve the optimal oil temperature.

The aftercooler has almost no influence on the specific output. Therefore, the aftercooler receives only as much water as necessary to achieve the desired, in particular maximum, compressed air outlet temperature T100, or the pressure condensation point M85, without coming to the boil, thus so that the temperature, for example T12, remains below 110° C.

Intercooling has a great influence on specific output and therefore receives as much water as possible.

The jacket cooling has the most influence on specific output and therefore receives a disproportionately large amount of water. The following temperature correlation can be used as the basis for the closed-loop control: T13-T10: =0.5*(T11-T10).

Should a component temporarily require better cooling, said component can also be better cooled.

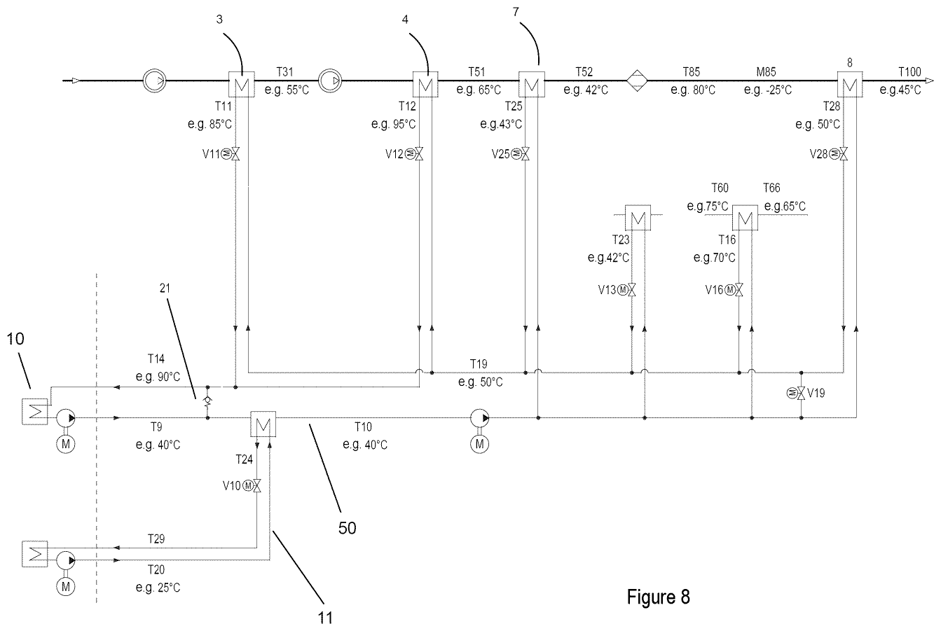

The embodiment of FIG. 8 corresponds substantially to the embodiment of FIG. 6 in a somewhat different illustration. Moreover, a primary bypass 21 and a primary bypass adjustment valve V19 are provided in the illustration of FIG. 8.

Here, in addition, a heat exchanger control valve V25 for an aftercooler is provided for the primary bypass adjustment valve V19, these are to be understood as two alternative embodiments. A plurality of optional embodiments are to be illustrated in greater clarity in one figure herewith.

Nevertheless, this embodiment having a primary bypass adjustment valve V19 and the heat exchanger control valve V25 could be implemented. This embodiment could be expedient in a special case, when warmer compressed air would be required in winter. In this instance, the valves V28 and V25 for the aftercooler would have to be closed to the extent that not enough water for the intercooler and aftercooler could be supplied without having to open the primary bypass adjustment valve V19.

As a result of the primary bypass adjustment valve V19 it can be achieved that a part of the coolant that has not passed through the third aftercooler 8 is supplied to the intercooler 3 and aftercooler 4. As in FIG. 6, it is also provided specifically in the embodiment of FIG. 8 that the intercooler 3 and the aftercooler 4 are disposed or interconnected in a series connection in the primary cooling circuit, but are mutually connected in parallel.

A temperature T85 can be recorded ahead of the cooler 8.

The following is to be noted in the context of the embodiments of FIGS. 5, 6 and 8. In these three embodiments, the intercooler 3 and the aftercooler 4 are connected in series relative to the primary cooling circuit, wherein the primary bypass adjustment valve V19 is ignored for the sake of simplicity for the explanation hereunder. The intercooler 3 and the aftercooler 4 thus conjointly receive the entire coolant flow, thus the overall coolant flow of the primary cooling circuit 50, because this is imposed by the series connection. Nevertheless, a mutual parallel connection of the intercooler 3 and of the aftercooler 4 is provided in all these three embodiments, however. It has thus been recognized that, nevertheless, an individual control means, specifically the adjustment valves V11 and V12 here, for the intercooler 3 and the aftercooler 4 are advantageous. Specifically, this permits control pertaining to the proportion of the overall coolant flow of the primary cooling circuit that flows through the intercooler 3, on the one hand, and the aftercooler 4, on the other hand. A distribution of cooling in the region between the two compressor stages, on the one hand, and directly after the second compressor stage, on the other hand, can thus be achieved.

The following advantages result for the embodiment of FIG. 8 and other embodiments:

Maximum heat recovery, at sufficient heat reduction, and operation without cooling water, are possible. It is thus conceived that the secondary cooling system 11 does not have to be utilized but can be on standby should less heat be required, or the compressor require better cooling.

A connected building heating system is proposed as an application for the above. This can have the following effect. In winter, the entire heat can be utilized by way of the heat exchanger 10. In contrast, less heat is required in summer, but the heat does nevertheless have to be discharged. In this instance, this takes place by way of the primary/secondary heat exchanger 9, the secondary cooling system 11 and the valve V10.

Depending on the temperature requirement and the alternative, approx. 10 . . . 30% more utilization of waste heat can be possible. A maximum utilization of waste heat is possible at a water inlet temperature which is higher by approx. 5K . . . 10K.

A very high water outlet temperature T14 is possible, in particular up to approximately ˜95° C.

Sufficient jacket cooling and oil cooling using heating water at a high volumetric flow is possible, in particular by way of the primary water system with the inflow and outflow temperatures T10 and T14, respectively.

A sufficient condensation point can be achieved because the cooler 7 receives a large volumetric flow of cool heating water.

A low compressed air outlet temperature is possible when required, because the cooler 8 receives cool heating water.

FIG. 9 shows a compressor installation 900 having a first and a second compressor stage 901 and 907, respectively, in a schematic, partially sectional illustration. In this context, FIG. 10 shows a first compressor stage 907 in an enlarged illustration. Reference hereunder is made to FIG. 9; to the extent that the first compressor stage is explained, reference is additionally made to FIG. 10.

FIG. 9 thus shows a dry-running screw compressor which substantially forms the compressor installation 900. During operation, the first compressor stage 901 thus carries out a compression of a first stage. For this purpose, the first compressor stage 901 has a housing 902, and coolant ducts 903 of a jacket cooling unit, which are illustrated more clearly in particular in FIG. 10.

Compressor screws 904 which for compressing engage in one another are provided for compressing the compressed gas, in particular the compressed air. Said compressor screws are driven by way of a drive shaft 905 of the corresponding compressor stage. The second compressor stage 907, which further compresses the gas, in particular compressed air, which has been compressed in the first compressor stage, has a housing 909 having coolant ducts 908 and compressor screws 910 which are driven by way of a drive shaft 911.

Both drive shafts 905 and 911 are driven by way of a common drive motor 906, and provided for this purpose is a gear unit 912 which distributes the drive output from the drive motor to the two drive shafts 905 and 911 so as to drive the compressor screws 904 and 910 as a result.

The two compressor stages 901 and 907 can be cooled by way of the jacket cooling which is implemented with the aid of the coolant ducts 903 and 908. For this purpose, a cooling medium, in particular cooling water, flows through these coolant ducts 903 and 908, and this can be controlled conjointly or individually.

According to the invention, at least according to one aspect, the following aspects are to be highlighted in particular.

Proposed is in particular a multistage dry-running compressor with water cooling, which comprises at least one intercooler, an aftercooler, an oil cooler and a compressor cooler, in particular jacket cooler, for cooling at least one compressor stage housing, which can also be referred to as a housing cooler. The intercooler and aftercooler form in each case a compressed gas cooler.

It is proposed that in each of these cooling devices, thus in each of these coolers, a water flow rate for discharging heat can be controlled in a closed loop separately by way of a dedicated closed-loop control member, in particular a control valve or a controllable pump. The closed-loop control member can also be referred to as a control means.

The following aspects can be additionally provided. At least two compressed air aftercoolers after a second compressor stage can be provided. At least one compressed air dryer having a downstream compressed air cooler for the dried compressed air can be provided. A device for cooling the at least one compressor housing is designed as a jacket cooling unit or jacket cooler, and/or provided is a heat exchanger for such a jacket cooling unit.

A closed-loop control member, or control means, is provided for closed-loop control of volumetric flows of water as closed-loop control of coolant flows per heat exchanger as a separate adjustment valve for each individual water flow path. In particular, a control unit of the cooling means is provided for each cooler. Each cooler can have in each case one supply strand by way of which the former is supplied with coolant. This includes in each case the supply and discharge of the coolant. Each supply strand can have an inflow and an outflow. For each cooler, a control means is preferably provided in each case in the supply strand of said cooler. This can be in each case in the inflow or in the outflow. A supply strand, in particular each supply strand, of in each case one cooler can be disposed parallel to the supply strands of some or all other coolers.

A control means, or closed-loop control member, for closed-loop control of the volumetric flows of water per heat exchanger can be embodied as a separate, controllable pump for each parallel strand, in particular thus for each supply strand. A control means, or closed-loop control member, can be provided for the closed-loop control of in each case one device, in particular of a cooler of at least one compressor housing. A parallel connection of the oil cooler and at least one of these devices, in particular coolers for cooling the at least one compressor housing, is proposed.

It is proposed that the control means, or closed-loop control members, are controlled in a closed loop, or coordinated, by a central or common control unit.

Different variants of circuit arrangements can be provided for the jacket cooling. One of those is a parallel connection of the oil cooler and the jacket cooling, or jacket cooler. Another one lies in providing an oil cooler and a heat exchanger of the jacket cooling in such a way that separate, or independent, closed-loop control of oil temperature and jacket cooling temperature is achievable.

A screw compressor is preferably provided as the compressor. Water, or a water/glycol mixture, can in particular be used as coolant.

Two variants can in particular be provided for actuating a control means, or closed-loop control member, for closed-loop control of a jacket cooling temperature when a heat exchanger is present for separation, which can also be referred to as system separation, in particular for separating the jacket cooling circuit from a primary cooling circuit. According to a first variant, open-loop or closed-loop controlling takes place directly in that a coolant flow, in particular a water flow rate, through the jacket cooling is controlled in an open loop or closed loop. According to a second variant, open-loop or closed-loop controlling takes place indirectly in that open-loop or closed-loop control of a coolant flow, or of a water flow rate, through the heat exchanger that exchanges heat with a coolant, in particular coolant of the jacket cooling, takes place.

The control means, or closed-loop control member, can be used for controlling the jacket cooling temperature in an open loop or closed loop when there is no heat exchanger present for system separation.

Proposed according to additional aspects is a dry-running compressor having liquid-cooled heat exchangers which are formed by at least one intercooler, at least one aftercooler, at least one oil cooler and at least one device for cooling the at least one compressor housing. Provided for this purpose are individual adjustment valves, or control valves, for the closed-loop control of the volumetric flows of water for each individual heat exchanger. Controlling coolant flows in an open loop or closed loop can be embodied in each embodiment as open-loop or closed-loop control of a volumetric flow of the respective coolant, in particular as open-loop or closed-loop control of the volumetric flow of water, when water is used as coolant. The temperatures of the at least one intercooler, of the at least one aftercooler, of the at least one oil cooler and of the at least one device for cooling the at least one compressor housing, which can be referred to as housing cooler, are controlled independently of one another in a closed loop. This takes place in particular in that the flow rate of the coolant through the coolers or devices mentioned is in each case controlled in an open loop or closed loop.

A mixed water outlet temperature, thus an outlet temperature of the overall coolant flow, which is referred to as T14 in the figures, is adjusted to a desired, in particular predefined, value in that volumetric flows of water are adjusted independently of one another and to individual, optionally to different, temperatures by heat exchangers connected in parallel in such a way that, after the convergence of the individual partial volumetric flows, thus of the individual coolant flows of the respective coolers, the desired overall water outlet temperature T14 results. For this purpose it is proposed that control means, in particular valves, in particular adjustment valves, are actuated or controlled by a common and/or central control unit.

The following closed-loop control can be provided. The oil cooler almost receives exactly the amount of water which is required for achieving the desired oil temperature (e.g. 70° C.). The compressed air aftercooler, in particular the aftercooler, or first aftercooler, almost receives exactly the amount of water which is required in order not to exceed the desired maximum compressed air outlet temperature, in order not to exceed the desired maximum pressure condensation point, and in order not to exceed the maximum permissible water temperature (e.g. 100° C.).

The water outlet temperature from the jacket cooling, thus from the housing cooler, is adjusted in such a way that the former is lower than the water outlet temperature from the intercooler.

According to a first aspect, the intercooler and the jacket cooling receive as much, or as little, water as necessary in order to achieve the desired mixed water outlet temperature.

According to a second aspect, the intercooler receives as much, or as little, water as necessary in order to achieve the desired mixed water outlet temperature T14.

It is proposed to carry out the closed-loop control in such a way that the temperature difference between the water inlet and the water outlet of the jacket cooling is approximately half the temperature difference between the water inlet and the water outlet of the intercooler. The value of half the temperature difference has been proven advantageous. In particular, this has been proven to be a good compromise. The optimal value of the factor can however also depend on which of the temperature differences T13-T10, T15-T10 and T23-T10 are set in relation to T11-T10.

It is furthermore proposed according to each aspect to maintain the mixed water outlet temperature at a predetermined or predefinable value. The value can vary as a function of the external temperature, and a heating curve can be predefined for this purpose.

The following method steps can be provided for setting the flow rates. The method steps can be prioritized in the sequence mentioned:

A compressed air supply is ensured, specifically an operation without malfunction.

A compressed air quality is ensured, specifically a predefinable pressure condensation point and a compressed air temperature.

Open-loop or closed-loop controlling then takes place in such a way that a desired water outlet temperature T14 is achieved.

In many aspects it is provided that delivery of the desired heat output takes place by way of the primary water system, thus a primary cooling circuit, in which recooling is provided by way of a secondary water system, which can take place by way of an adjustment valve, in particular an adjustment valve V10 shown in the figures.

Controlling then takes place in such a way that a minimum energy consumption of the compressor is achieved.

Furthermore proposed according to an aspect is closed-loop controlling of the pressure condensation point, if a compressed air dryer is used and a measured value for the moisture is available. For this purpose, the pressure condensation point or the absolute humidity or the relative humidity can be measured directly.

When using a refrigeration dryer, the temperature can also be measured at a cold location and a conclusion pertaining to the pressure condensation point can be drawn directly therefrom.

When the pressure condensation point after the dryer becomes too high, the control then provides that the heat exchanger/exchangers ahead of the dryer, thus at least one of the compressed gas coolers upstream of the dryer, receives more and/or colder cooling water. In particular, the coolant flow through the at least one compressed gas cooler is increased.

When using an adsorption dryer, which is regenerated with compressor heat, the intercooler receives less water, thus less coolant, in order to achieve a higher outlet temperature from the compressor, in particular from a second compressor stage, in order for said higher outlet temperature to be utilized for regenerating the dryer.

In the closed-loop control of the water valves the following measured temperatures are, inter alia, taken into account, wherein the reference signs relate to the figures in which they are plotted:
a compressed air outlet temperature T100 from the compressor installation, which, depending on the embodiment, can be a compressed air outlet temperature from the last heat exchanger or from the dryer, and thus the temperature at which the compressed gas, in particular the compressed air, is delivered for further use, wherein a measured value of one of the temperature points T85 or T52 or T51 or T4 can be used for T100, also depending on where the compressor installation ends;
an oil temperature, in particular an oil inlet temperature in the oil cooler T60,
an oil temperature upstream of an oil cooler,
an oil outlet temperature from a compressor stage,
air outlet temperature from aftercooler T51,
air outlet temperature from intercooler T31,
water outlet temperature from intercooler T11,
water outlet temperature from aftercooler T12,
water outlet temperature from jacket cooling, or from a heat exchanger of a jacket cooling T13, T15, T23,
air and water outlet temperatures from optional additional heat exchangers 7, specifically the temperatures T52 and T25, and heat exchanger after the dryer 8, specifically the temperatures T86 and T28; and
air outlet temperature from compressor stages T2 and T4.

According to one aspect, an embodiment of heat recovery is provided. A water inlet temperature T10 for the heat exchangers in the primary cooling circuit is controlled in a closed loop by way of a water/water heat exchanger by way of an adjustment valve V10. The heat recovery output is adjusted as a result.

When the water inlet temperature T10 is lower in comparison to an average value, the electrical energy consumption of the compressor is correspondingly somewhat lower, and the utilizable waste heat output is significantly lower due to the smaller volumetric flow of water through the primary water circuit.

When the temperatures T9 and T10 are low, the waste heat output can be higher. The waste heat output becomes only significantly lower when T10 is less than T9, i.e. when heat is discharged by way of the heat exchanger 9 and the secondary cooling system 11.

Further aspects can be provided.

Waste heat utilization can be provided, wherein the entire heat of the compressor can be discharged into the primary water system (e.g. heating water). This means that the waste heat from the heat exchangers can be discharged by way of the primary water system, depending on the heat requirement and temperature profile. In other embodiments, part of the waste heat can be discharged by way of the secondary cooling system.

However, a small part of the waste heat is also dispensed by way of the cooling air. An additional small part of the compression heat can be discharged by way of the compressed air.

Recooling of the primary water (e.g. heating water) can be provided by way of the secondary circuit (e.g. cooling water)
when less heat from the primary circuit is required on the side of the building, for example in the case of connected heating, or other elements connected on the side of the building,
in order to improve the specific output, and/or
when individual components in the compressor require better cooling, and an inlet temperature of the supplying primary cooling circuit, referred to as T9 in the figures, is too hot for this purpose.

According to one aspect it is proposed that a complete internal circuit having a pump, an expansion vessel, a bypass and optionally additional elements is provided. In this way, the compressor can also be operated without being connected to a primary water system on the side of the building (e.g. in the event of a failure of the heating system).

In this aspect, the water on the primary side is circulated internally only through the pump 12b and the bypass 21. FIG. 4 illustrates the aspect by way of example.

One aspect, in which a bypass V19 can be provided as a variant, is shown in FIG. 8.

The aspect is proposed when the intercooler and the aftercooler in total require more water than the upstream heat exchangers. This can occur during a cold start as an extreme example, when the adjustment valves V16, V13, V28, V25 are closed but the adjustment valves V11 and V12 are opened, in particular completely opened.

Provided according to one aspect is closed-loop control of the jacket cooling for optimal cooling. As a result, positive cooling is achievable because the jacket cooling has a great influence on the specific output, thus in particular the output/volumetric flow of the compressor. It is proposed here that the cooling must not be adjusted too extremely in order to prevent excessive scuffing on the compressor stages, in particular scuffing on rotor and housing coatings of the compressor stages.

This is based in particular here on the concept that the cooling of the compressor stages should ideally be positive, but also should ideally be constant in the long-term. For the short-term, the colder the better applies in a simplified manner, as long as there is no condensed water.

However, this low temperature also has to be permanently maintained. As this is often impossible, it may be better to apply only moderate cooling in winter, so that these temperatures can also be achieved in summer.

When the stage is cooled “too well”, thus excessively, the housing becomes smaller and the coating of the housing and of the rotors suffers further scuffing. If this remains like this permanently, this may be positive. However, if the housing, or the jacket cooling, becomes warmer and thus larger again later on, the gaps become larger and the compressor specifically deteriorates.

As one aspect, it is proposed to minimize a compressed air temperature prior to entering a second compressor stage. In FIG. 8, this temperature can be found at the temperature measuring point T31, or can also be understood to be T31. This aspect is proposed in order to minimize specific output of the compressor. The intercooler that cools the compressed air that is partially compressed at this temperature measuring point receives as much water as possible for this purpose. It is provided to this end that the coolers 7 and 8 and the oil cooler receive only as much water as necessary. This is provided in order to minimize pre-heating of the coolant prior to entering the intercooler, at the measuring point T19 in FIG. 8. In the process, the aftercooler 4 receives as little water as possible, but so much that the temperature does not become too high at the outlet of the aftercooler 4, at the measuring point T12 in FIG. 8. The pressure condensation point and the target value for the optimal compressed air outlet temperature should ideally be achieved.

According to one aspect it is proposed to adjust an oil temperature upstream of the oil cooler to a predefinable target value. In this context, it has been recognized that a predefinable maximum temperature of the oil ahead of the oil cooler, at the measuring point T60 in FIG. 7, is more relevant for the service life of the oil, the bearings and the gear units than an injection temperature downstream of the oil cooler, at the measuring point T66 in FIG. 7. It has been recognized that in the case of high oil heating this leads to a cooler injection temperature at the temperature measuring point T66. As a result, bearings under a high load, or under intense heating, can be better cooled. As a result, it is possible to keep constant an oil temperature which is still not cooled, therefore high, in particular at T60, wherein an oil temperature which is cooled, therefore low, in particular at T66, varies depending on a load on the bearings, and optionally other loads.

The following aspects by way of which the invention, or at least aspects thereof, is distinguished from the prior art, are still to be mentioned, or have been recognized according to the invention.

The jacket cooling has to be cooled, or has to cool, positively as uniformly as possible. Permanently constantly positive cooling would be optimal. However, the water temperature fluctuates significantly in most instances in practice.

Many solutions from the prior art (cf. WO 2022/163079 A1) therefore cool the jacket cooling using pre-heated water by way of a series connection with the oil cooler, in order to avoid that the compressor housing is excessively cooled and thus becomes too small, which would lead to the undesirably intense scuffing of the rotor and housing coating of the compressor stages. The functional mode of this scuffing can be derived from patent application EP 3399191 A1.

Other solutions from the prior art do cool the jacket cooling using cool (not pre-heated) water, but cannot control it independently in a closed loop. In the case of cold cooling water, this can indeed lead to very good specific values, but also leads to more intense scuffing of the rotor and housing coating. As a result, the gaps are unnecessarily large in the later (normal) operation at a higher water temperature, as a result of which there is more backflow, which has a negative effect on the specific output of the compressor.

As a result of the closed-loop control of the flow rate through the jacket cooling, it can be prevented by the invention that the jacket cooling is excessively cooled at an excessively low water temperature. Thus, more uniform and better cooling can also be achieved using non-pre-heated water according to the invention, which has a permanently positive effect on the specific output of the compressor.

According to the invention, the jacket cooling in particular is now cooled with cool water, i.e. non-pre-heated water, and the flow rate through the jacket cooling—and thus the jacket cooling temperature T13, or the housing temperature and the housing size—is controlled in a closed loop, independently of other heat exchangers.

According to the invention, it is proposed in particular to use tightly closing valves. In this way, the flow through the individual parallel strands can also be completely suppressed. This is the case, for example, at a standstill, but also during a cold start. Here, the intercooler and the aftercooler are already passed through by a flow, while the oil cooler and the jacket cooling initially do not receive any water at all for some time until the respective operating temperatures have been reached.

The separate closed-loop control of the jacket cooling is thus a proposed aspect.

Moreover, the following are aspects according to the invention.

Proposed is separate open-loop or closed-loop control of housing cooling, in particular of the jacket cooling, which is separate from the other cooling units, in which the flow rate of the coolant and/or temperature of the coolant are/is controlled.

Moreover proposed is open-loop or closed-loop control of an outlet temperature of a common coolant flow, in particular of a primary cooling circuit of the compressor installation. This temperature can also be referred to as a mixed outlet temperature and is plotted at the temperature measuring point T14 in the figures. In this context it is proposed to implement the outlet temperature mentioned by a plurality of control means, in particular parallel closed-loop control members, which individually adjust to different temperatures.

It has been recognized and is proposed according to the invention according to one aspect to operate the jacket cooling with the primary, warmer heat recovery water, or with the secondary, cooler cooling water as a function of a ratio between a current price of electricity and a current price of heat, on the one hand, and a difference between primary heat recovery temperatures and secondary cooling water temperatures.

A price per kWh can be used as the electricity price, thus in ct/kWh, for example. The price of heat mentioned can depend on a price of gas plus further operating costs and efficiency rates, or on any other price of primary energy.

This is based on the concept that it is considered in summer that other, more cost-effective heat sources, in particular other primary energy sources, are available.

It is to be taken into account here that costs can also be set for waste heat from the compressor. The higher the temperature level, the more expensive the waste heat of the compressor, because the specific output [kwh/m³] simultaneously deteriorates.

However, it has been recognized that the waste heat of the compressor can in most instances be assumed to be substantially more cost-effective than the heat generation by way of gas burners.

It is proposed to optimize the heat offering in particular when a heat requirement is lower than the maximum possible heat offering of the compressor installation.

Optimizing of this type can take place by reducing the temperature T10, so as to hereby reduce the temperature T31. Depending on the previous profile, or the gap measurement of the compressors and temperature level, a reduction of the temperature T13, or the temperature T15, can also be purposeful. Both are proposed as possible aspects here.

Both measures can reduce the energy consumption and simultaneously increase the mass flow of the compressed gas, so that the specific output drops.

One aspect of the invention is closed-loop control of the jacket cooling. This applies in particular to dry-running screw compressors. Such closed-loop control is potentially not, or less, important in the case of oil-injected or water-injected compressors. Therefore, the use of dry-running screw compressors is in particular proposed.

Turbo pistons, scroll pistons, tooth pistons, rotary pistons and reciprocating pistons could be used and are examples of dry-running compressors.

It has been recognized in particular that jacket cooling is of particularly great importance in dry-running screw compressors. Therefore, the invention, or at least aspects thereof, is/are provided in particular for use with dry-running screw compressors.

1. A compressor installation, comprising
a compressor for compressing a gas for generating a compressed gas, and
a cooling installation, the cooling installation comprises
an oil cooler for cooling oil heated by the compressor,
a compressed gas cooler for cooling the gas which is completely or partially compressed to the compressed gas, and
a housing cooler for cooling a housing or part of the housing of the compressor, wherein
the oil cooler, the compressed gas cooler, and the housing cooler are in each case prepared to achieve cooling by a coolant flow from a liquid coolant, and wherein
in each case for the coolant flow of the oil cooler, the coolant flow of one of the compressed gas cooler and the coolant flow of the housing cooler is
an individual, actuatable control means so as to individually control each of the coolant flows in such a way that a cooling output is in each case individually controllable for the oil cooler, the compressed gas cooler, and the housing cooler.

2. The compressor installation of claim 1, wherein
the oil cooler,
the compressed gas cooler, and
the housing cooler,
are connected to a primary cooling circuit in a parallel connection.

3. The compressor installation of claim 2, wherein
the compressor includes a plurality of compression stages, and
the compressed gas cooler includes an intercooler and an aftercooler, and wherein
the intercooler cools gas which is partially compressed to the compressed gas between a first and second compression stage, and
the aftercooler cools the compressed gas at the outlet of the compressor after having passed through the plurality of compression stages, and/or
the intercooler and/or the aftercooler each include individual, actuatable control means.

4. The compressor installation of claim 1, wherein
the control means each have a controllable valve and/or a controllable pump.

5. The compressor installation of claim 3, wherein the housing cooler
includes at least one jacket cooler, the at least one jacket cooler having
a plurality of jacket sub-coolers connected in series, each cooling one compressor stage and are prepared to use the same cooling flow for cooling, and to control the cooling flow by the same control means.

6. The compressor installation of claim 1, further comprising
a common control installation for controlling the coolant flow in a coordinated manner, and wherein
the common control installation is prepared for controlling the control means and connected to the control means.

7. The compressor installation of claim 1, wherein
the compressor is a dry-running compressor, and/or
a screw compressor which is designed to compress the gas by a movement of a plurality of mutually engaging screws.

8. The compressor installation of claim 5, further comprising
one or more additional compressed gas coolers which in terms of a flow direction of the compressed gas is/are disposed behind the compressor so as to further cool the compressed gas there, wherein
the one or more additional compressed gas coolers
uses/use in each case a coolant flow which is in each case controlled by a dedicated individual control means, and
is/are connected to a same, or the same, primary cooling circuit as the oil cooler, the compressed gas cooler and/or the housing cooler, in particular in a parallel connection, and/or
is/are connected to a second medium cooling circuit as a secondary cooling circuit, which operates separately or is coupled to the primary cooling circuit by a heat exchanger.

9. The compressor installation of claim 1, wherein
the oil cooler, the compressed gas cooler and/or the housing cooler each include
one heat exchanger, or are designed as a heat exchanger, and are prepared in such a way that the respective coolant flow is controlled by the respective control means as a cooling flow through the respective heat exchanger.

10. The compressor installation of claim 8, wherein
the compressor installation, in particular the cooling installation, is prepared to control the respective coolant flows individually, in each case as a function of a temperature, and wherein
controlling taking place as a function of at least one temperature measured by a sensor system, the at least one temperature selected from a group consisting of
an oil temperature, in particular of the oil heat by the compressor,
a compressed gas temperature,
a jacket temperature of a coolant which flows through a housing jacket of the compressor,
a temperature of the coolant,
an oil inlet temperature as the temperature of the oil entering the oil cooler
an aftercooler gas outlet temperature as the temperature of the compressed gas exiting the aftercooler,
an intercooler gas outlet temperature as the temperature of the compressed gas exiting the intercooler,
an intercooler coolant outlet temperature as the temperature of the coolant exiting the intercooler
an aftercooler coolant outlet temperature as the temperature of the coolant exiting the aftercooler,
a jacket cooler coolant outlet temperature as the temperature of the coolant exiting the at least one jacket cooler,
a respective gas or coolant outlet temperature as the temperature of a compressed gas exiting at least one heat exchanger or of exiting coolant,
a compressor gas outlet temperature as the temperature of a compressed gas exiting a compressor stage of the compressor and/or the compressor, and/or exiting the compressor installation
and
a cooling circuit coolant outlet temperature as a temperature of the coolant at an outlet of the coolant from the primary and/or secondary cooling circuit, and/or in that
the compressor installation is prepared in such a way that at least one coolant flow is controlled as a function of a pressure condensation point of the compressed gas, measured by a sensor system.

11. The compressor installation of claim 10, wherein
the compressor installation, in particular the cooling installation, is prepared in such a way that coolant flows are controlled in such a way that
the overall coolant outlet temperature, as the temperature of the coolant exiting the primary and/or secondary cooling circuit, is controlled in a closed loop to a predefinable target outlet temperature.

12. The compressor installation of claim 10, wherein
the compressor installation, in particular the cooling installation, is prepared in such a way that
the coolant flow of the oil cooler by means of the respective control means is controlled in such a way that a predefined oil temperature is adjusted, and/or
the coolant flow of one of the compressed gas cooler, in particular of the aftercooler, by means of the respective control means is controlled in such a way that a predefined compressed gas outlet temperature is not exceeded and/or not undershot, and/or
the coolant flow of one of the housing cooler, in particular of the at least one jacket cooler is controlled in such a way that a coolant outlet temperature of this coolant is lower than a coolant outlet temperature of one of the compressed gas cooler, in particular of the intercooler, and/or
the coolant flow of one of the housing cooler, in particular of the at least one jacket cooler, is controlled in such a way that a difference between the coolant outlet temperature when the coolant exits the housing cooler, at a coolant inlet temperature when this coolant enters the housing cooler, according to the value is
below a predeterminable first value, and/or
above a predeterminable second value, and/or
between a predeterminable third and fourth value.

13. A method for operating a compressor installation, the compressor installation comprising
a compressor for compressing a gas for generating compressed gas, and
a cooling installation, and the cooling installation comprises
an oil cooler for cooling oil heated by the compressor,
a compressed gas cooler for cooling the gas which is completely or partially compressed to the compressed gas, and
a housing cooler for cooling a housing or part of the housing of the compressor, wherein
the oil cooler, the compressed gas cooler and the housing cooler achieve in each case cooling by a coolant flow from a liquid coolant, and wherein
each coolant flow is individually controlled by an individual, actuatable control means in such a way that a cooling output is in each case controlled individually for the oil cooler, the compressed gas cooler and the housing cooler.

14. The method for operating the compressor installation of claim 13, wherein the compressor installation further comprises
a plurality of compression stages in the compressor, and
an intercooler and an aftercooler in the compressed gas cooler, and wherein
the intercooler cools gas which is partially compressed to the compressed gas between a first and second compression stage, and
the aftercooler cools the compressed gas at the outlet of the compressor after having passed through the plurality of compression stages, and/or
the intercooler and/or the aftercooler each include individual, actuatable control means.
